(19) United States
(12) Patent Application Publication
(10) Pub. No.: US 2016/0110365 A1
(43) Pub. Date: Apr. 21, 2016

(54) SYSTEMS AND METHODS FOR LOCATING CONTAGION SOURCES IN NETWORKS WITH PARTIAL TIMESTAMPS

(71) Applicant: ARIZONA BOARD OF REGENTS ON BEHALF OF ARIZONA STATE UNIVERSITY, Tempe, AZ (US)

(72) Inventors: Kai Zhu, Tempe, AZ (US); Lei Ying, Tempe, AZ (US)

(21) Appl. No.: 14/880,103

(22) Filed: Oct. 9, 2015

Related U.S. Application Data
(60) Provisional application No. 62/061,760, filed on Oct. 9, 2014.

(51) Int. Cl. G06F 17/30

(52) U.S. Cl. CPC G06F 17/3053; G06F 17/30958; G06F 17/30961

(57) ABSTRACT

Systems and methods of identifying a contagion source when partial timestamps of a contagion process are disclosed. A source localization problem is formulated as a ranking problem on graphs, where infected nodes are ranked according to their likelihood of being the source.

### CROSS-REFERENCE TO RELATED APPLICATIONS

This is a non-provisional application that claims benefit to U.S. provisional application Ser. No. 62/061,760 filed on Oct. 9, 2014, which is herein incorporated by reference in its entirety.

### GOVERNMENT SUPPORT

This invention was made with government support under W911 NF-13-1-0279 awarded by the Army Research Office. The government has certain rights in the invention.

### FIELD

The present disclosure generally relates systems and methods for identifying a contagion source when partial timestamps of a contagion process are available, and in particular to identifying a contagion source as a ranking problem on graphs, wherein infected nodes are ranked according to their likelihood of being the contagion source.

### BACKGROUND

Contagion processes can be used to model many real-world phenomena, including rumor spreading in online social networks, epidemics in human beings, and malware on the Internet. Informally speaking, locating the source of a contagion process refers to the problem of identifying a node in the network that provides the best explanation of the observed contagion.

This source localization problem has a wide range of applications. In epidemiology, identifying patient zero can provide important information about the disease. For example, in the Cholera outbreak in London in 1854, the spreading pattern of the Cholera suggested that the water pump located at the center of the spreading was likely to be the source. Later, it was confirmed that the Cholera indeed spreads via contaminated water. In online social networks, identifying the source can reveal the user who started a rumor or the user who first announced certain breaking news. For rumors, rumor source detection helps hold people accountable for their online behaviors; and for news, the news source can be used to evaluate the credibility of the news.

While locating contagion sources has these important applications in practice, the problem is difficult to solve, in particular, in complex networks. A major challenge is the lack of complete timestamp information, which prevents us from reconstructing the spreading sequence to trace back the source. But on the other hand, even partial timestamps, which are available in many practical scenarios, provide important insights about the location of the source. The focus of this paper is to develop source localization algorithms that utilize partial timestamp information.

While this source localization problem (or called rumor source detection problem) has been studied recently under a number of different models, most of them ignore timestamp information. As we will see from the experimental evaluations, even limited timestamp information can significantly improve the accuracy of locating the source.

### BRIEF DESCRIPTION OF THE DRAWINGS

FIG. 1 is a simplified illustration of nodes showing available information;

FIG. 2 is a simplified illustration showing a spreading tree that is feasible and consistent with the observation of FIG. 1;

FIGS. 3A-3E are simplified illustrations of trees formed by blue edges for various iterations;

FIG. 4 is a graph showing a comparison with Existing Algorithms in an IAS network with 50% timestamps;

FIG. 5 is a graph showing a comparison with existing algorithms in a PG network with 50% timestamps;

FIG. 6 is a graph illustrating the impacts of the distribution and size of timestamps in the IAS network;

FIG. 7 is a graph showing the impacts of the distribution and size of timestamps in the PG network;

FIG. 8 is a graph showing the performance of CR, TR and GAU in the IAS network under the SpikeM model;

FIG. 9 is a graph showing the performance of CR, TR and GAU in the PG network under the SpikeM model;

FIG. 10 is a graph showing the γ %-Accuracy as the Number of Removed Edges Increases;

FIG. 11 is a graph showing the performance on Weibo data;

FIG. 12 is a graph showing the performance of CR, TR in the IAS network under the SpikeM model with partially observed infected nodes;

FIG. 13 is a graph showing the performance of CR, TR in the PG network under the SpikeM model with partially observed infected nodes;

FIG. 14 is a simplified illustration showing a subnetwork prior to modification;

FIG. 15 is a simplified illustration showing a subnetwork after incorporating information 6 and 7; and

FIG. 16 is an example computing system that may implement various systems and methods discussed herein

Corresponding reference characters indicate corresponding elements among the view of the drawings. The headings used in the figures do not limit the scope of the claims.

### DETAILED DESCRIPTION

The present disclosure addresses the source localization problem as a ranking problem on graphs, where infected nodes are ranked according to their likelihood of being the source. In some embodiments, a spreading tree is defined to include (i) a directed tree with all infected nodes; and (ii) the complete timestamps of contagion propagation. Given a spreading tree rooted at node v, denoted by Pᵥ, a quadratic cost C(Pᵥ) is generated depending on the structure of the tree and the timestamps. The cost of node v is then defined to be

$$C ( v ) = {min}_{{𝒫}_{v}} C ( {𝒫}_{v} ) . \qquad ( 1 )$$

For example, the minimum cost among all spreading trees rooted at Node v. Based on the costs and spreading trees, two ranking methods may be implemented that:
(i) rank the infected nodes in an ascendant order according to C(v), called cost-based ranking (CR), and
(ii) find the minimum cost spreading tree, i.e.,

$${𝒫}^{*} = arg {min}_{𝒫} C ( 𝒫 ) ,$$

(iii) rank the infected nodes according to their timestamps on the minimum cost spreading tree, called tree-based ranking (TR).

The computational complexity of C(v) is very high due to the large number of possible spreading trees. Problem (1) has been proven to be NP-hard by connecting it to the longest-path problem.

In some embodiments, the system 100 includes a greedy algorithm, named Earliest Infection First (EIF), to construct a spreading tree to approximate the minimum cost spreading tree for a given root Node v, denoted by P̅ᵥ. The greedy algorithm is designed based on the minimum cost solution for line networks. EIF first sorts the infected nodes with observed timestamps in an ascendant order of the timestamps, and then iteratively attaches these nodes using a modified breadth-first search algorithm. In CR, the infected nodes are then ranked based on C( P̅ᵥ); and in TR, the nodes are ranked based on the complete timestamps of the spreading tree P̅* such that

P̅*=arg min C( P̅ᵥ).

For infected nodes with unknown infection time, EIF assigns the infection timestamps during the construction of the spreading tree P̅ᵥ. The details can be found in Section 3.

TABLE 1
The 10%-accuracy under different source
localization algorithms with 50% timestamps

| | CR | TR | GAU | NETSLEUTH | ECCE | RUM |
|---|---|---|---|---|---|---|
| IAS | 0.76 | 0.68 | 0.57 | 0.43 | 0.15 | 0.15 |
| PG | 0.98 | 0.99 | 0.98 | 0.43 | 0.43 | 0.39 |

Extensive experimental evaluations were conducted using both synthetic data and real-world social network data (Sina Weibo1). The performance metric is the probability with which the source is ranked among top γ percent, named γ %-accuracy. We have the following observations from the experimental results: ¹ http://www.weibo.com/

Both CR and TR significantly outperform existing source location algorithms in both synthetic data and real-world data. Table 1 summarizes the 10%-accuracy in the Internet autonomous systems (IAS) network and the power grid (PG) network. The readers could refer to Section 5.2 for the abbreviations of other baseline algorithms.

Our results show that both TR and CR perform well under different contagion models and different distributions of timestamps.

Early timestamps are more valuable for locating the source than recent ones.

Network topology has a significant impact on the performance of source localization algorithms, including both ours and existing ones. For example, the γ %-accuracy in the IAS network is lower than that in the PG network (see Table 1 for the comparison). This suggests that the problem is more difficult in networks with small diameters and hubs than in networks that are locally tree-like.

### A Ranking Approach for Source Localization

Ideally, the output of a source localization algorithm should be a single node, which matches the source with a high probability. However, with limited timestamp information, this goal is too ambitious, if not impossible, to achieve. From the best of our knowledge, almost all evaluations using real-world networks show that the detection rates of existing source localization algorithms are very low, where the detection rate is the probability that the detected node is the source.

When the detection rate is low, instead of providing a single source estimator, a better and more useful output of a source localization algorithm would be a node ranking, where nodes are ordered according to their likelihood of being the source. With such a ranking, further investigation can be conducted to locate the source. The more accurate the ranking, the lesser amount of resources are required for further investigation. Furthermore, the authority may only have the resources to search a small portion of the entire network. Therefore, we also want the ranking is more accurate at the top, called the accuracy at the top in. The γ % accuracy is evaluated, which is the probability that the source is ranked among the top γ percent and the normalized rank.

In one particular embodiment, the source localization algorithm described herein may be applied to a communication network comprised of several computing device. For example, malware may be spread from one computing device to another over a communication network, such as the Internet. In this example, the source localization algorithm may be utilized to determine from which computing device connected to or otherwise in communication with the network the malware program started to spread. In general, the network may include any number of computing devices that may communicate with each other utilizing the network. One example of such a network includes a telecommunications network forming the backbone or supporting network for the Internet. In another example, mobile computing devices, such as cell phones or tablets, may connect to the network wirelessly to transmit and receive data from the network. In this example, the various nodes of the algorithm discussed below correspond to one or more computing devices connected or in communication with the network. As mentioned, source localization algorithm may aid a system administrator in determining from which computing device connected to the network a particular program or dataset originated and spread through the other computing devices of the network. In yet another example, the particular dataset provided from the originating device is a text string or file that is sent to one or more other computing devices over the network.

The source localization algorithm includes the following information:
A network G(V, E): The network is an unweighted and directed graph. A Node v in the network represents a physical entity (such as a user of an online social network, a human being, or a mobile device). A directed edge e(v, u) from Node v to Node u indicates that the contagion can be transmitted from Node v to Node u.
A set of infected nodes I: An infected node is a node that involves in the contagion process, e.g., a twitter user who retweeted a specific tweet, a computer infected by malware, etc. It is assumed that I includes all infected nodes in the contagion. As such, I forms a connected subgraph of G. In the case I includes only a subset of infected nodes, our source localization algorithms rank the observed infected nodes according to their likelihood of being the earliest infected node. More discussion can be found in Section 6.
Partial timestamps T: T is a |V|-dimensional vector such that Tᵥ=* if the timestamp is missing and otherwise, Tᵥ is the time at which Node v was infected. It is noted that the time here is the normal clock time, not the relative time with respect to the infection time of the source. Note that in most cases, the infection time of the source is as difficult to know as the location of the source. In addition, it is assumed the observed timestamps are exact without any error or noise.

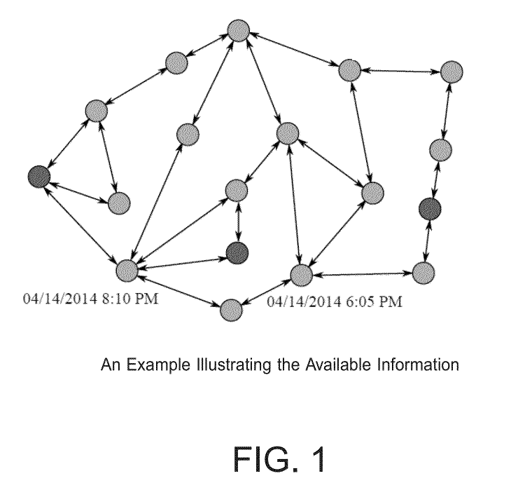

FIG. 1A is a simple example showing the available information. The nodes in orange are the infected nodes. The time next to a node is the associated times-tamp. A spreading tree P=(T, t) is defined to be a directed tree T with a |T|-dimensional vector t. The directed tree T specifies the sequence of infection and the vector t specifies the time at which each infection occurs. It is further required the time sequence t of a spreading tree to be feasible such that the infection time of a node is larger than its parent's, and to be consistent with the partial timestamps T such that tᵥ=Tᵥ if Tᵥ≠*. FIG. 1B shows a spreading tree that is feasible and consistent with the observation shown in FIG. 1A. Note that, for simplicity, we omitted the date in the figure by assuming all events occur on the same day. The timestamps in black are the observed timestamps and the ones in blue are assigned by us. Denote by L(I, T) the set of spreading trees that are both feasible and consistent with the partial timestamps.

### Quadratic Cost and Sample Path Approach

Given a spreading tree P=(T, t)εL(I, T), the cost of the tree is defined to be for some constant μ>0.

$$C ( 𝒫 ) = {\sum }_{( v , w ) ∈ T} {( {t}_{w} - {t}_{v} - μ )}^{2} , \qquad ( 2 )$$

This quadratic cost function is motivated by a continuous time SI model. Each node has two possible states: susceptible and infected. The infection propagates via edges. For each edge (v, w)εT, assume that the time it takes for Node v to infect Node w follows a truncated Gaussian distribution with mean μ and variance σ². Then given a spreading tree P, the probability density associated with time sequence t is

$${f}_{v} ( t ) = {\prod }_{( v , w ) ∈ T} \frac{1}{Z \sqrt{2 π } σ} exp ( - \frac{{( {t}_{w} - {t}_{v} - μ )}^{2}}{2 {σ}^{2}} ) , \qquad ( 3 )$$

where Z is the normalization constant. Note each node can be only infected by its parent when the spreading tree is given. Therefore, the log-likelihood is

$$log {f}_{𝒫} ( t ) = - \vert ℰ ( 𝒯 ) \vert log ( Z \sqrt{2 π} σ ) - \frac{1}{2 {σ}^{2}} {\sum }_{( v , w ) ∈ 𝒯} {( {t}_{w} - {t}_{v} - μ )}^{2} ,$$

where |E(T)| is the number of edges in the tree. Therefore, given a tree T, the log-likelihood of time sequence t is inversely proportional to the quadratic cost defined in (2). The lower the cost, the more likely the time sequence occurs. While the quadratic cost is justified by the truncated Gaussian SI model, the algorithms based on the quadratic cost can be used on any diffusion model. The performance of the proposed algorithms will be evaluated under different diffusion models and networks in Section 5.

Now given an infected node in the network, the cost of the node is defined to be minimum cost among all spreading trees rooted at the node. Using Pᵥ to denote a spreading tree rooted at Node v, the cost of Node v is

$$C ( v ) = {min}_{{𝒫}_{v} ∈ ℒ ( ℐ , τ )} C ( 𝒫 ) . \qquad ( 4 )$$

After obtaining C(v) for each infected node v, the infected nodes can be ranked according to either C(v) or the timestamps of the minimum cost spreading tree. However, the calculation of C(v) in a general graph is NP-hard as shown in the following theorem.

Theorem 1:

Problem (4) is an NP-Hard Problem.

Remark 1:

This theorem is proved by showing that the longest-path problem can be solved by solving (4). The detailed analysis is presented in the appendix. Since computing the exact value of C(v) is difficult, the system 100 uses a greedy algorithm as discussed in the next section.

EIF: A Greedy Algorithm

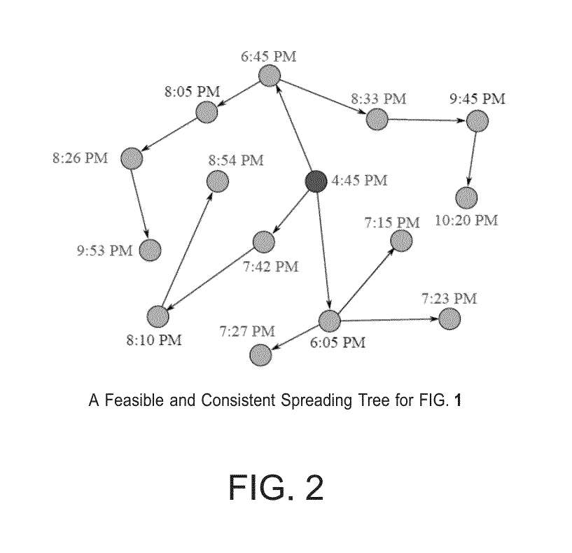

In some embodiments, the system 100 uses a greedy algorithm, named Earliest-Infection-First (EIF), to solve problem (4). Note that if a node's observed infection time is larger than some other node's observed infection time, then it cannot be the source. So the system 100 only needs to compute cost C(v) for Node v such that τᵥ=* or τᵥ=min_{u:τ}_{ᵤ}_{≠v}τᵤ. Furthermore, when all infected nodes are known, the network can be restricted to the subnetwork formed by the infected nodes to run the algorithm. In one embodiment, all edges are bidirectional, so the arrows are omitted, and the network in FIG. 2 is the subnetwork formed by all infected nodes.

### Earliest-Infection-First (EIF)

Step 1:

The algorithm first estimates μ from T using the average per-hop infection time. Let I_{vw} denote the length of the shortest path from Node v to Node w, then

$$μ = \frac{{\sum }_{{τ}_{c} \neq * , {τ}_{w} \neq * , v \neq w} \vert {τ}_{v} - {τ}_{w} \vert}{{\sum }_{{τ}_{v} \neq * , {τ}_{w} \neq * , v \neq w} {I}_{vw}} .$$

Example: Given the timestamps shown in FIG. 2, μ=36.94 minutes.

Step 2:

Sort the infected nodes in an ascending order according to the observed infection time T. Let α denote the ordered list such that α1 is the node with the earliest infection time.
Example: Consider the example in FIG. 2. The ordered list is

α=(6,12,13,1).

Step 3:

Construct the initial spreading tree T₀ that includes the root node only and set the cost to be zero.
Example: Assuming the cost of Node 10 in FIG. 2 is to be computed, T₀={10} and C(10)=0.

Step 4:

At the k^{th} iteration, Node αₖ is added to the spreading tree Tₖ₋₁ using the following steps.
Example: At the 3^{rd} iteration, the current spreading tree is

10→6→7→8→12,
and the associated timestamps are given in Table 2. Note that these timestamps are assigned by EIF except those observed ones. The details can be found in the next step. In the 3^{rd} iteration, Node 13 needs to be added to the spreading tree.

TABLE 2
The timestamps on the spreading tree in the 3^{rd} iteration

| node ID | 10 | 6 | 7 | 8 | 12 |
|---|---|---|---|---|---|
| Timestamp | 5:28 | 6:05 | 6:45 | 7:25 | 8:05 |

For each node m on the spreading tree Tₖ₋₁, identify a modified shortest path from Node m to Node αₖ. The modified shortest path is a path that has the minimum number of hops among all paths from Node m to Node αₖ, which satisfy the following two conditions:
it does not include any nodes on the spreading tree Tₖ₋₁, except node m;
it does not include any nodes on list α, except node αₖ.
Example: The modified shortest path from Node 7 to Node 13 is

7→9→13.

There is no modified shortest path from Node 12 to Node 13 since all paths from 12 to 13 go through Node 8 that is on the spreading tree T₂.
(a) For the modified shortest path from Node m to Node αₖ, the cost of the path is defined to be

$${γ}_{m} = {{\overline{l}}_{{α}_{k} m} ( \frac{{t}_{{α}_{k}} - {t}_{m}}{{\overline{l}}_{{α}_{k} m}} - μ )}^{2} ,$$

Where l_{α}_{ₖ}ₘ denotes the length of the modified shortest path from m to αk. From all nodes on the spreading tree Tₖ₋₁, select Node m* with the minimum cost i.e.,

$${m}^{*} = arg {min}_{m} {γ}_{m} .$$

Example: The costs of the modified shortest paths to the nodes on the spreading tree

10→6→7→8→12
are shown in Table 3. Node 7 has the smallest cost.

TABLE 3
The costs of the modified shortest paths

| node ID | 10 | 6 | 7 | 8 | 12 |
|---|---|---|---|---|---|
| cost | 15,640.00 | ∞ | 61.83 | 147.03 | ∞ |

(b) Construct a new spreading tree Tₖ by adding the modified shortest path from m* to αₖ. Assume Node g on the newly added path is h_{g} hops from Node m*, the infection time of Node g is set to be

$${t}_{g} = {t}_{{m}^{*}} + ( {h}_{g} - 1 ) \frac{{t}_{{α}_{k}} - {t}_{{m}^{*}}}{{\overline{l}}_{{m}^{*} {α}_{k}}} .$$

The cost is updated to C(v)=C(v)+γm*.
Example: At the 3rd iteration, the timestamp of Node 9 is set to be 7:28 PM, and the cost is updated to C(10)=89.92.

Step 5:

For those infected nodes that have not been added to the spreading tree, add these nodes by using a breadth-first search starting from the spreading tree T. When a new node (say Node w) is added to the spreading tree during the breadth-first search, the infection time of the node is set to be t_{pw}+μ, where p_{w} is the parent of Node w on the spreading tree. Note that the cost C(v) does not change during this step because t_{w}−t_{pw}−μ=0.
Example: The final spreading tree and the associated timestamps are presented in FIG. 2.

Remark 2:

The timestamps of nodes on a newly added path are assigned according to Equation (5). This is because such an assignment is the minimum cost assignment in a line network in which only the timestamps of two end nodes are known.

Lemma 1:

Consider a line network with n infected nodes. Assume the infection times of Node 1 and Node n are known and the infection times of the rest nodes are not. Furthermore, assume T₁<Tₙ. The quadratic cost defined in (4) is minimized by setting

$${t}_{k} = {τ}_{1} + ( k - 1 ) \frac{{τ}_{n} - {τ}_{1}}{n - 1} for 1 < k < n . \qquad \begin{matrix}( 6 ) \\ □\end{matrix}$$

Note that under the assignment above, the infection time, Tₖ₊₁−Tₖ, is the same for all edges, which is due to the quadratic form of the cost function.

Remark 3:

Note that in Step 4(a), the modified shortest path is used instead of the conventional shortest path. The purpose is to avoid inconsistence when assigning timestamps. For example, consider the 3^{rd} iteration in FIG. 2, and the paths from Node 7 to Node 2. There are two conventional shortest paths: 7→4→5→1 and 7→8→5→1. If path 7→8→5→1 is selected and assigned the timestamps according to (5), then the infection time of Node 8 is larger that of Node 7, which contradicts the current timestamps of Node 7 and Node 8. Therefore, 7→8→5→1 should not be selected.

Remark 4:

A key step of EIF is the construction of the modified shortest paths from the nodes on Tₖ₋₁ to Node αₖ. This can be done by constructing a modified breadth-first search tree starting from Node αₖ. In constructing the modified breadth-first search tree, first reverse the direction of all edges to construct paths from the nodes on Tₖ₋₁ to Node αₖ. Then starting from Node αₖ, nodes are added in a breadth-first fashion. However, a branch of the tree terminates when the tree meets a node on Tₖ₋₁ or Node α₁ for l>k. After obtaining the modified breadth-first search tree, if a leaf node is a node on Tₖ₋₁, say Node m, then the reversed path from Node αₖ to Node m on the modified breadth-first search tree is a modified shortest path from Node m to Node αₖ. If none of the leaf nodes is on Tₖ₋₁, then the cost of adding αk is claimed to be infinity. In FIG. 2, the trees formed by the blue edges are the modified breadth-first trees at each iteration.

The pseudo code of the EIF algorithm is presented in Algorithm 1.

Algorithm 1: Earliest-Infection-First Algorithm

| | Input: τ, G_{I}, υ^{†}; | |
|---|---|---|
| | Output: C̅( T̅_{υ}^{†}) (Cost of υ^{†}), T̅_{υ}^{†} (Spreading tree associated with υ^{†}); | |
| 1 | Set | |
| | | $μ = \frac{{Σ}_{{\overline{T}}_{υ} \neq * , {\overline{T}}_{ω} \neq * , υ \neq ω} \vert {T}_{υ} - {T}_{ω} \vert}{{Σ}_{{\overline{T}}_{υ} \neq * , {\overline{T}}_{ω} \neq * , υ \neq ω} {l}_{υω}} ,$ |
| 2 | Sort τ in an ascending order. Denote by αᵢ the ith node according | |
| | to the order. | |
| 3 | Set T₀ to be a tree that includes only υ^{†} and set C̅ = 0. | |
| 4 | Set N to be the length of τ. | |
| 5 | for κ = l to N do | |
| 6 | \| for Node m in Tree T_{κ-1} do | |
| 7 | \| \| Identify the modified shortest path P_{mακ} from m to α_{κ}. | |
| 8 | \| \| Compute | |
| | \| \| \| \| \| └ | ${γ}_{m} = {{\overline{l}}_{{α}_{κ} m} ( \frac{{t}_{{α}_{κ}} - {t}_{m}}{\vert {P}_{{mα}_{k}} \vert} - μ )}^{2} ,$ |
| 9 | \| Select m* ε arg minₘ γₘ. | |
| 10 | \| Set the infection time of Node g ε P_{m*ακ} to be | |
| | \| \| \| | ${t}_{g} = {t}_{{m}^{*}} + ( {h}_{g} - 1 ) \frac{{t}_{{α}_{κ}} - {t}_{{m}^{*}}}{{\overline{l}}_{{m}^{*} {α}_{κ}}}$ |

| | |
|---|---|
| | \| where h_{g} is the number of hops from m* to g on P_{m*ακ}. |
| 11 | \| Add P_{m*ακ} to T_{κ-1} to obtain T_{κ}. |
| 12 | └ set C = C + γ_{m*}. |
| 13 | Let Q be an empty queue and enqueue all nodes on T_{N}. |
| 14 | while Q is not empy do |
| 15 | \| Dequeue Q, Let m be the dequeued node. |
| 16 | \| for All edges from m to υ in G_{I} do |
| 17 | \| \| if υ is not in T_{N} then |
| 18 | \| \| \| Add edge (m, υ) to T_{N}. |
| 19 | \| \| \| Set t_{υ} = tₘ + μ. |
| 20 | └ └ └ Enqueue υ to Q. |
| 21 | Set C̅( T̅_{υi}) = C̅ᵢ T̅_{υi} = T_{N} |
| 22 | return C̅( T̅_{υi}) and T̅_{υi}. |

Cost-Based and Tree-Based Ranking

Denote by τ̅ᵥ the spreading tree constructed under EIF for Node v, and C̅( τ̅ᵥ) the corresponding cost computed by EIF. After constructing the spreading tree for each infected node and obtaining the corresponding cost, the nodes are ranked using the following two approaches.

Cost-Based Ranking (CR): Rank the infected nodes in an ascendant order according to C̅( τ̅ᵥ).

Tree-Based Ranking (TR): Denote by v*=arg minᵥ C̅( τ̅ᵥ). Rank the infected nodes in an ascendant order according to the timestamps on τ̅_{v*}.

Theorem 2:

The complexity of CR and TR is O(|α∥I∥ε_{I}|, where |α| is the number of infected nodes with observed timestamps, |I| is the number of infected nodes, and |E_{I}| is the number of edges in the subgraph formed by the infected nodes.

CR and TR algorithms can be implemented in a distributed fashion where C̅( τ̅ᵥ) could be computed parallelly for each node v.

Experimental Evaluation

The performance of TR and CR was evaluated using both synthetic data and real-world data. While both ranking algorithms (TR and CR) were justified by the sample path based approach based on the truncated Gaussian distribution, one important contribution of the two algorithms is that they are parameter-free and model-free and can be used for any diffusion model and network. In fact, the objective of the system 100 is the development of such a general algorithm. Of course, the theoretical analysis can only be done for a specific model, but extensive simulations for different diffusion models were conducted including the IC model and SpikeM model and further under real social network data sets.

### 5.1 Performance of EIF on a Small Network

In the first set of simulations, the performance of EIF was evaluated for solving the minimum cost of the feasible and consistent spreading trees. Given an observation I and T, denote by C* the minimum cost of the feasible and consistent spreading trees. Then

$${C}^{*} = {min}_{𝒫 ∈ ℒ ( ℐ , τ )} C ( 𝒫 )$$

Denote by C̅* the minimum cost of the spreading trees obtained under EIF. The approximation ratio

$$r = \frac{{C}^{*}}{{C}^{*}}$$

was evaluated on a small network—the Florentine families network which has 15 nodes and 20 edges. Recall that the minimum cost problem is NP-hard, so the approximation ratio is evaluated over a small network only. To compute the actual minimum cost, all possible spanning trees were enumerated using an algorithm and then computed the minimum cost of each spanning tree by solving the quadratic programming problem.

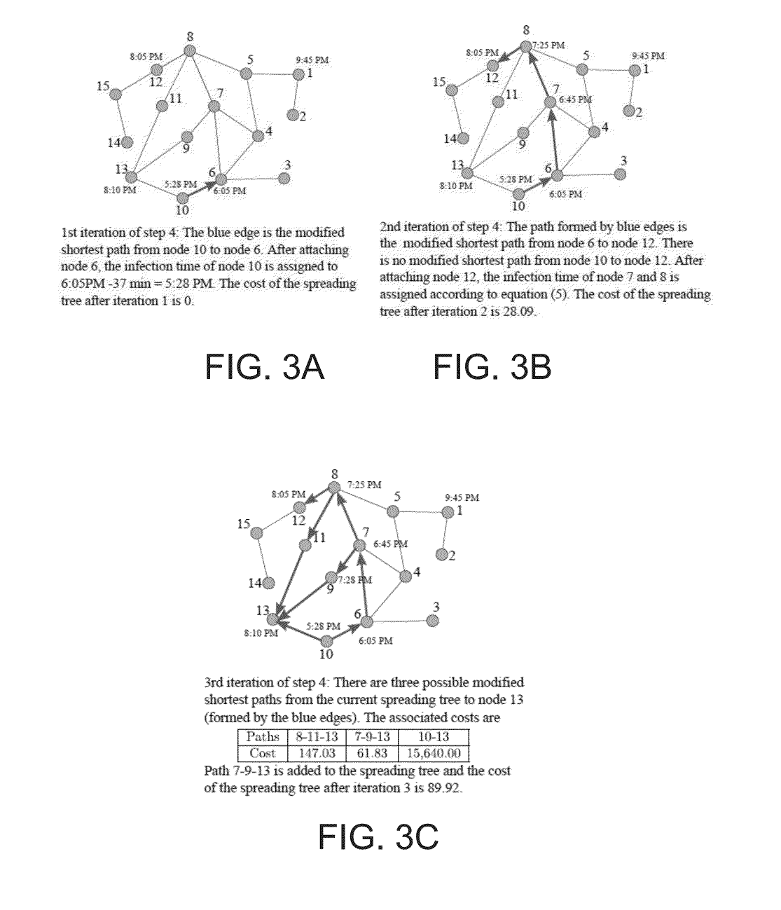

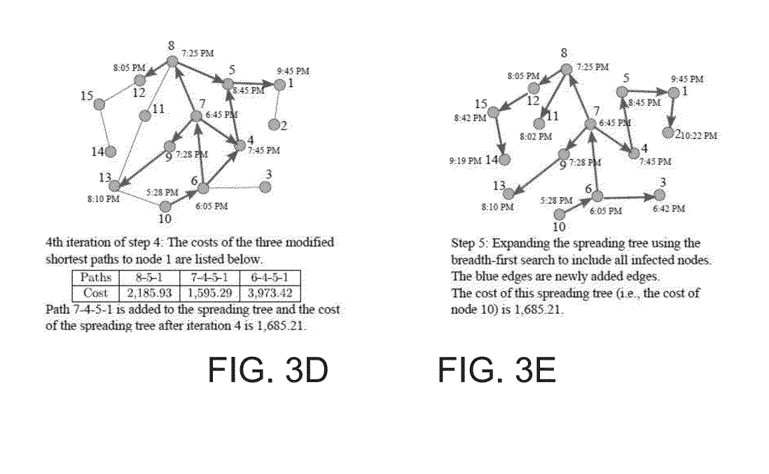

In this experiment, the infection time of each edge is assumed to follow a truncated Gaussian distribution with μ=100 and σ=100. We evaluated the approximation ratio when the number of observed timestamps varied from 5 to 14. The results are shown in FIGS. 3A-3E, where each data point is an average of 500 runs. The error bar shows the mean±standard deviations. Since the ratio cannot be smaller than 1.0, the error bar is cut off at 1.0. The approximation ratio is 2.24 with 5 timestamps, 1.5 with 8 timestamps and becomes 1.08 when 14 timestamps are given. This experiment shows that EIF approximates the minimum cost solution reasonably well.

5.2 Comparison with Other Algorithms

Algorithms were first tested using synthetic data on two real-world networks: the Internet Autonomous Systems network (IAS)² and the power grid network (PG)³: ² Available at http://snap.stanford.edu/data/index.html
The IAS network is a network of the Internet autonomous systems inferred from Oregon route-views on Mar. 31, 2001. The network contains 10,670 nodes and 22,002 edges in the network. IAS is a small world network.
The PG network is a network of Western States Power Grid of United States. The network contains 4,941 nodes and 6,594 edges. Compared to the IAS network, the PG network is locally tree-like.

CR and TR were first compared with the following four existing source localization algorithms.
Rumor centrality (RUM): Rumor centrality is the maximum likelihood estimator on trees under the SI model. RUM ranks the infected nodes in an ascendant order according to nodes' rumor centrality.
Infection eccentricity (ECCE): The infection eccentricity of a node is the maximum distance from the node to any infected node in the graph, where the distance is defined to be the length of the shortest path. The node with the smallest infection eccentricity, named Jordan infection center, is the optimal sample-path-based estimator on tree networks under the SIR model. ECCE ranks the infected nodes in a descendent order according to infection eccentricity.
NETSLEUTH: The algorithm constructs a submatrix of the infected nodes based on the graph Laplacian of the network and then ranks the infected nodes according to the eigen-vector corresponding to the largest eigenvalue of the submatrix.
Gaussian heuristic (GAU): Gaussian heuristic is an algorithm that utilizes partial timestamp information. The algorithm is similar to CR in spirit, but uses the breadth-first search tree as the spreading tree for each infected node.

In the four algorithms above, RUM, ECCE, and NETSLEUTH only use topological information of the network, and do not exploit the timestamp information. GAU utilizes partial timestamp information.

In this set of experiments, it is assumed the infection time of each infection follows a truncated Gaussian distribution with μ={1, 10, 100} and σ=100. In each simulation, a source node was chosen uniformly across node degree to avoid the bias towards small degree nodes (In the IAS network, 3,720 out of the 10,670 nodes have degree one). In particular, the nodes were grouped into M bins such that the nodes in the m^{th} bin (1≦m≦M−1) have degree m and the nodes in the M^{th} bin have degree ≧M. In each simulation, a bin is randomly and uniformly picked, and then a node is randomly and uniformly picked from the selected bin. The contagion process is simulated and the process is terminated when having 200 infected nodes. For the IAS network, we chose M=20; and for the PG network, we chose M=10. Since there are less than 10 nodes with degree 21 and the total number of nodes with degree larger than 20 is 205 in the IAS network. Therefore, 20 bins are used to make sure there are enough nodes in each bins. On the other hand, the maximum degree of the PG network is only 19, so 10 bins are used in the PG network.

50% infected nodes (100 nodes) were selected and revealed their infection time. The source node was always excluded from these 100 nodes so that the infection time of the source node was always unknown. The simulation was repeated 500 times to compute the average γ %-accuracy. Recall the γ %-accuracy is the probability with which the source is ranked among top γ percent.

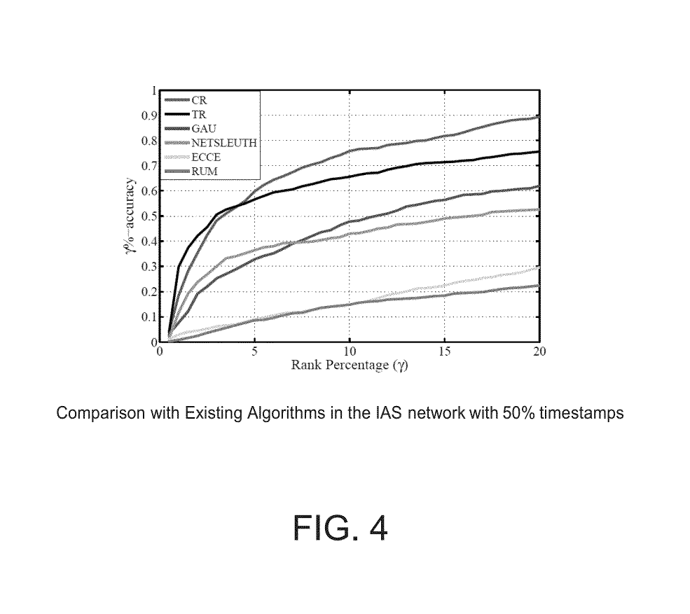

The results on the IAS and PG networks are presented in FIG. 4 where the performance was consistent for different μ values. Recall that RUM, ECCE and NETSLEUTH only use topological information.
Observation 1: In both networks, CR and TR performed much better than the other algorithms in the IAS network. In PG network, TR, CR and GAU had similar performance which dominates other algorithms due to the utilization of the timestamp information. In particular, in the IAS network, the 10%-accuracy of CR is 0.76 while 10%-accuracy of GAU and NETSLEUTH is 0.57 and 0.43, respectively when μ=100. In the PG network, the 10%-accuracy of TR is 0.99 while that of GAU and NETSLEUTH is 0.98 and 0.43, respectively.
Observation 2: Most algorithms, except NETSLEUTH, have higher γ %-accuracy in the PG network than in the IAS network. It was concluded that it is because the IAS network has a small diameter and contains hub nodes while the PG network is more tree-like.
Observation 3: NETSLEUTH dominates ECCE and RUM in the IAS network, but performs worse than ECCE and RUM in the PG network when γ≦10. Furthermore, while all other algorithms have higher γ-accuracy in IAS than in PG, NETSLEUTH has lower γ-accuracy in IAS than in PG when γ<10. A similar phenomenon will be observed in a later simulation as well.
Observation 4: CR performs better in the IAS network when γ≧5 while TR performs better in the PG network.

### 5.3 the Impact of Timestamp Distribution

In the previous set of simulations, the revealed timestamps were uniformly chosen from all timestamps except the timestamp of the source, which was always excluded. This is referred to as unbiased distribution. In this set of experiments, we study the impact of the distribution of the timestamps. The unbiased distribution was compared with a distribution under which nodes with larger infection time are selected with higher probability. In particular, the nodes were iteratively selected. Let N^{k} denote the set of remaining infected nodes after selecting k nodes, then the probability that Node i is selected in the next step is

$${𝓅}_{i}^{( k )} - \frac{{t}_{i} - {t}_{k}}{{\sum }_{j ∈ {𝒩}^{*}} ( {t}_{j} - {t}_{k} )} ,$$

where tₛ is the infection time of the source. This is referred to as time biased distribution.

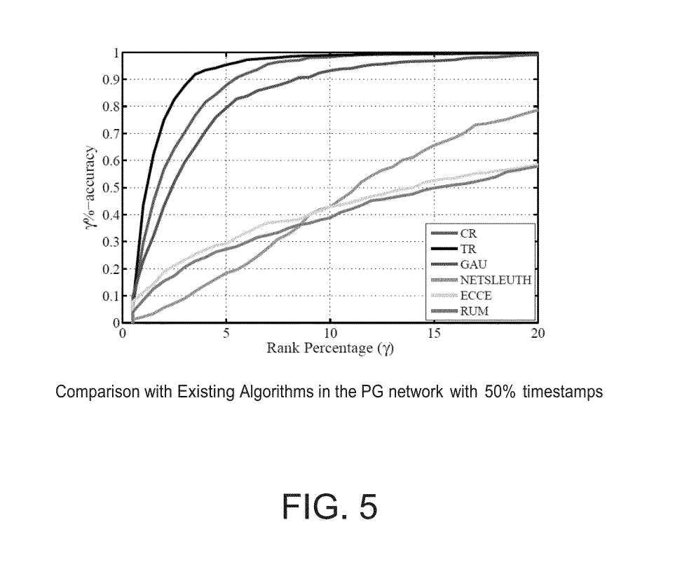

The performance of the algorithms and GAUs were evaluated with different sizes of observed timestamps and different distributions of the observed timestamps. All the experiment setups are the same as in Section 5.2. The algorithms were evaluated with μ={1, 10, 100} and the results of different number of timestamps are shown in FIG. 5.

Note that the performance of RUM, ECCE and NETSLEUTH are independent of timestamp distribution and size, so these algorithms are not included in the figures. From the FIG. 5, the following observations were made:
Observation 5: The sizes of observed timestamps were varied from 10% to 90%. As expected, the γ %-accuracy increases as the size increases under both CR and TR. Interestingly, in the IAS network, the 10%-accuracy of GAU is worse than TR and CR when more than 20% of the timestamps are observed. It was concluded that this is because in small world networks such as the IAS network, the spreading tree is very different from the breadth-first search tree rooted at the source. Since GAU always uses the breadth-first search trees regardless of the size of timestamps, more timestamps do not result in a more accurate spreading tree. The spreading tree constructed by EIF, on the other hand, depends on the size of timestamps and is more accurate as the size of timestamps increases.
Observation 6: In both networks, the time-biased distribution results in 5% to 15% reduction of the γ %-accuracy. This shows that earlier timestamps provide more valuable information for locating the source. However, the trends and relative performance of the three algorithms are similar to those in the unbiased case.
Observation 7: CR performs better in the IAS network when the timestamp size is larger than 40%; and TR performs better in the PG network.
Observation 8: The γ %-accuracy is much higher in the PG network than that in the IAS network under both the unbiased distribution and time-biased distribution. For example, with the time-biased distribution and 20% of timestamps, the 10%-accuracy of TR is 0.87 in PG and is only 0.52 in IAS when μ=100. This again confirms that the source localization problem is more difficult in networks with small diameters and hub nodes.

### 5.4 the Impact of the Diffusion Model

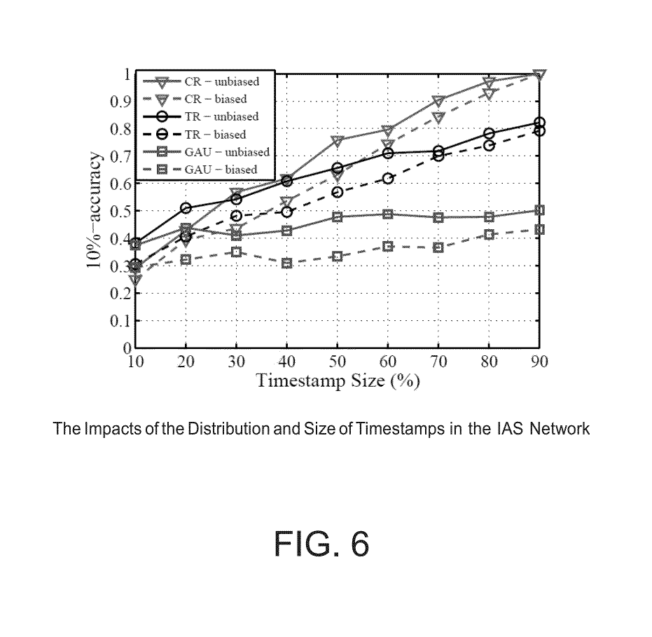

In all previous experiments, the truncated Gaussian model was used for contagion. The robustness of CR and TR to the contagion models will now be discussed. Experiments were conducted using the IC model and SpikeM model for contagion. Both models are time slotted, so are very different from the truncated Gaussian model. In the IC model, each infected node has only one chance to infect each of its neighbors. If the infection failed, the node cannot make more attempts. In the experiments, the infection probability along each edge is selected with a uniform distribution over (0, 1). SpikeM model has been shown to match the patterns of real-world information diffusion well. In the SpikeM model, infected nodes become less infectious as time increases. Furthermore, the activity level of a user in different time periods of a day varies to match the rise and fall patterns of information diffusion in the real world. In these experiments, the parameter set C5 in Table 3 was used, which was obtained based on MemeTracker dataset. The results are shown in FIG. 6, where in each figure, the size of timestamps varies from 10% to 90%.
Observation 9: Under both the IC and SpikeM models, the GAU algorithm has a better performance when less than 20% timestamps are observed in the IAS network. The performance of TR and CR dominate GAU when more than 20% timestamps are observed. For the PG network, the performances of TR and CR are better than GAU under the IC model, and the performance of TR is better than GAU under the SpikeM model.
Remark 5: Another popular diffusion model is the Linear Threshold (LT) model. However, in the experiments, it was found that it is difficult for a single source to infect more than 150 nodes under the LT model. Therefore, we only conducted experiments with the IC model.

### 5.5 the Impact of Network Topology

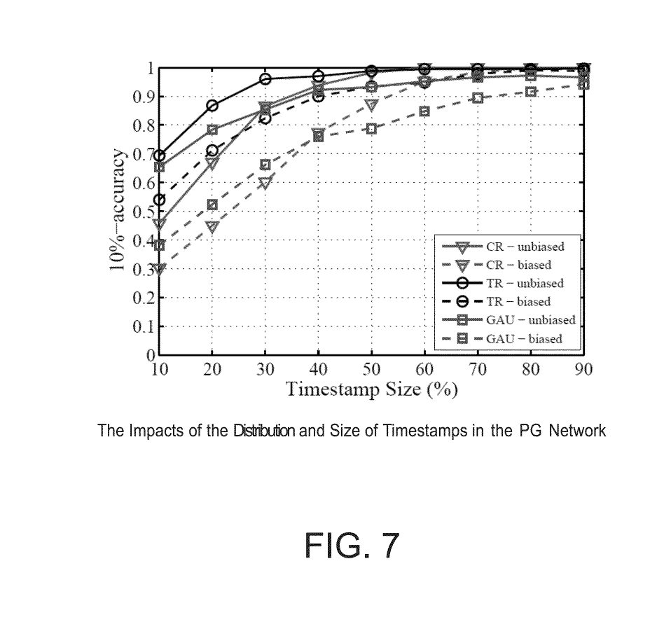

In the previous simulations, it was observed that locating the source in the PG network is easier than in the IAS network. It was concluded that it is because the IAS network is a small-world network while the PG network is more tree-like. To verify this conjecture, the edges were removed from the IAS network to observe the change of γ %-accuracy as the number of removed edges increases. For each removed edge, one edge was randomly picked and removed it if the network remains to be connected after the edge is removed. The truncated Gaussian model was used and all other settings are the same as those in Section 5.2. The results are shown in FIG. 7.
Observation 10: After removing 11,000 edges, the ratio of the number of edges to the number of nodes is 11, 002/10, 670=1.03, so the network is tree-like. As showed in FIG. 7, the 5%-accuracy of all algorithms, except NETSLEUTH, improves as the number of the removed edges increases, which confirms our conjecture. The 5%-accuracy of NETSLEUTH starts to decrease when the number of removed edges is more than 6,000. This is consistent with the observation we had in FIG. 4, in which the 5% accuracy of NETSLUETH in PG is worse than that in IAS.

TABLE 4
Statistics of Extracted Tweet Cascades

| | |
|---|---|
| Average Tweet cascade size (number of | 332.19 |
| Average diameter (longest shortest path) | 6.86 |
| Average out degree | 3.60 |

### 5.6 Weibo Data Evaluation

The performance of the algorithms was evaluated with real-world network and real-world information spreading. The dataset is the Sina Weibo⁴ data, provided by the WISE 2012 challenge. Sina Weibo is the Chinese version of Twitter, and the dataset includes a friendship graph and a set of tweets.

The friendship graph is a directed graph with 265,580,802 edges and 58,655,849 nodes. The tweet dataset includes 369,797,719 tweets. Each tweet includes the user ID and post time of the tweet. If the tweet is a retweet of some tweet, it includes the tweet ID of the original tweet, the user who posted the original tweet, the post time of the original tweet, and the retweet path of the tweet which is a sequence of user IDs. For example, the retweet path a→b→c means that user b retweeted user a's tweet, and user c retweeted user b's.

Tweets with more than 1,500 retweets were selected. For each tweet, all users who retweet the tweet are viewed as infected nodes and we extracted the subnetwork induced by these users. Those edges were also added on the retweet paths to the subnetwork if they were not present in the friendship graph, by treating them as missing edges in the friendship network. The user who posted the original tweet is regarded as the source. If there does not exist a path from the source to an infected node along which the post time is increasing, the node was removed from the subnetwork. In addition, to make sure of enough timestamps, the samples with less than 30% timestamps were removed.

After the above preprocessing, there are 1,170 tweets with at least 30% observed timestamps. Some statistics of the extracted tweet cascades are listed in Table 4.

Similar to Section 5.2, the tweets were grouped into five bins according the degree of the source in the friendship graph. In the k^{th} bin (for k=1, 2, 3, 4), the degree of the source is between 8000(k−1) to 8000k−1.

TABLE 5
10%-accuracy for Different Tweet Cascade Sizes

| | Tweet cascade size | | | | |
|---|---|---|---|---|---|
| | [10, | [200, | [400, | [600, | [800, |
| | 200) | 400) | 600) | 800) | ∞) |
| | Number of samples | | | | |
| | 285 | 126 | 106 | 76 | 145 |
| CR-30% | 0.87 | 0.82 | 0.71 | 0.55 | 0.63 |
| CR-10% | 0.92 | 0.70 | 0.50 | 0.47 | 0.60 |
| TR-30% | 0.95 | 0.91 | 0.84 | 0.79 | 0.86 |
| TR-10% | 0.94 | 0.79 | 0.71 | 0.64 | 0.69 |
| GAU-30% | 0.93 | 0.73 | 0.55 | 0.47 | 0.57 |
| GAU-10% | 0.91 | 0.67 | 0.41 | 0.41 | 0.43 |
| NETSLEUTH | 0.92 | 0.76 | 0.58 | 0.55 | 0.55 |
| ECCE | 0.91 | 0.68 | 0.55 | 0.57 | 0.56 |
| RUM | 0.94 | 0.64 | 0.63 | 0.53 | 0.48 |

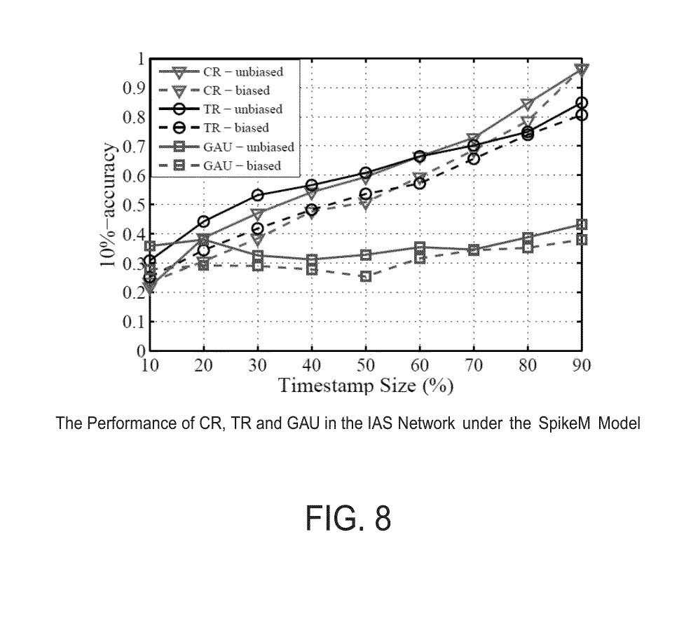

In the 5th bin, the degree of the source is at least 32,000. The number of tweets in the bins are 568 147 70 68 317. From each bin, 30 samples were drawn without replacement. For completeness, we also evaluated the performance with all 1,170 tweets. The results are summarized in FIG. 8. FIG. 8A shows the performance with all tweets samples and shows the performance if the tweets are resampled by the above degree bins. The observed timestamps are uniformly selected from the available timestamps and the source node is excluded. The 10%-accuracy was also investigated for different tweet cascade sizes. The results are shown in Table 5. The reason that the first tweet cascade size bin is [10,200) is that the samples with <10 nodes will always have zero 10%-accuracy.
Observation 11: FIGS. 8A and 8B show that CR and TR dominates GAU with both 10% and 30% of timestamps. In particular for the resample by degree case, TR performs very well and dominates all other algorithms with a large margin. The 10%-accuracy of TR with 30% timestamps is around 0.64 while that of CR is 0.53 and that of NETSLEUTH is only 0.4.
Observation 12: As shown in Table 5, for small cascade sizes, all methods have similar accuracy. When the cascade size increases, the performance of our TR algorithm with 30% timestamps dominates all other algorithms. In particular, with same amount of timestamps, TR is much better than GAU which again demonstrated the effectiveness of our algorithm.
Summary: From the synthetic data and real data evaluations, we have seen that both TR and CR perform better than existing algorithms, and are robust to diffusion models and timestamp distributions. Furthermore, TR performs better than CR in most cases. CR performs better than TR only in the IAS network when the sample size is large (≧30% under the truncated Gaussian diffusion, ≧50% under the IC model and ≧70% under the SpikeM model).

### 6.1 Other Side Information

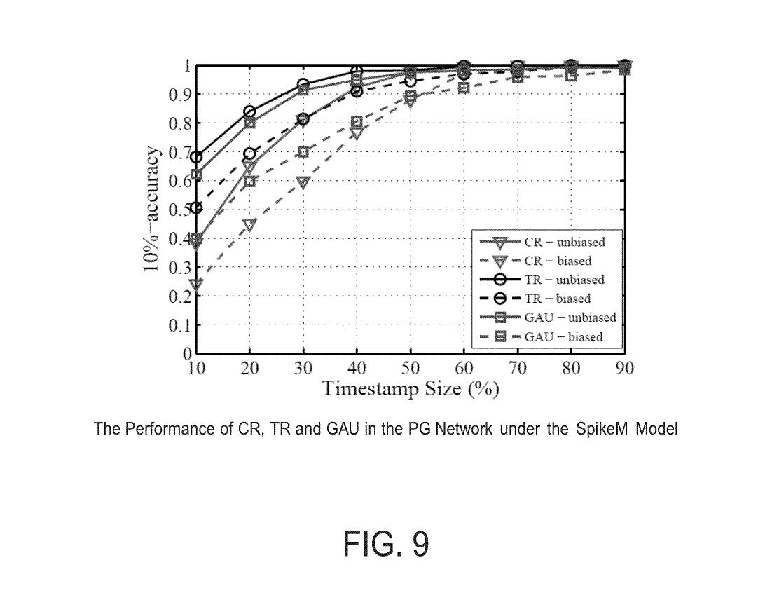

In some practical scenarios, other side information than timestamps such as who infected whom is considered. This side information can be incorporated in the algorithm by modifying the network G. Consider the example in FIG. 9A. If it is known that Node 2 was infected by Node 3, then all incoming edges to Node 2 can be removed, except 3→2, and the edge 2→3 to obtain a modified G as shown in FIG. 9B. CR and TR are applied on the modified graph to rank the observed infected nodes.

### A Proof of Lemma 1

Define x_{k,k-1}=tₖ−tₖ₋₁, so the cost C can be written as

$$C ( x ) = {\sum }_{k = 2}^{n} {( {t}_{k} - {t}_{k - 1} - μ )}^{2} = {\sum }_{k = 2}^{n} {( {x}_{k , k - 1} - μ )}^{2} .$$

The cost minimization problem can be written as

min C(x)=Σₖ₌₂ⁿ(x_{k,k-1}−μ)² (7)

subject to: Σₖ₌₂ⁿx_{k,k-1}=tₙ−t₁ (8)

x_{k,k-1}≧0. (9)

Note that C(x) is a convex function in x. By verifying the KKT condition (Boyd and Vandenberghe, 2004), it can be shown that the optimal solution to the problem above is

$${x}_{k , k - 1} = \frac{{τ}_{n} - {τ}_{1}}{n - 1} ,$$

which implies

$${t}_{k} = {τ}_{1} + ( \hat{k} - 1 ) \frac{{τ}_{n} - {τ}_{1}}{n - 1} .$$

### Proof of Theorem 1

Assume all nodes in the network are infected nodes and the infection time of two nodes (say Node v and Node w) are observed. Without loss of generality, assume Tᵥ<T_{w}. Furthermore, assume the graph is undirected (i.e., all edges are bidirectional) and

|τᵥ−τ_{w}|≧μ(|I|−1).

The theorem is proven by showing that computing the cost of Node v is related to the longest path problem between Nodes v and w.

To compute C(v), we consider those spreading trees rooted at Node v are considered. Given a spreading tree P=T, t rooted at Node v, denote by Q(v,w) the set of edges on the path from Node v to Node w. The cost of the spreading tree can be written as

$$\begin{matrix}C ( 𝒫 ) = {\sum }_{( h , u ) ∈ ℰ ( 𝒯 ) \backslash 𝒬 ( v , w )} {( {t}_{u} - {t}_{h} - μ )}^{2} + & ( 10 ) \\ {\sum }_{( h , u ) ∈ 𝒬 ( v , w )} {( {t}_{u} - {t}_{h} - μ )}^{2} & ( 11 )\end{matrix}$$

Recall that only the infection time of Nodes v and w are known. Furthermore, Nodes v and w will not both appear on a path in τ\Q(v,w). Therefore, by choosing τᵤ−τₕ=μ for each (h,u)εε(τ)\Q(v,w), we have

(10)=0.

Next applying Lemma 1, we obtain that

$$( 11 ) \geq \vert 𝒬 ( v , w ) \vert {( \frac{{τ}_{w} - {τ}_{v}}{\vert 𝒬 ( v , w ) \vert} - μ )}^{2} , \qquad ( 12 )$$

where the equality is achieved by assigning the timestamps according to Lemma 1.

For fixed |T_{w}−Tᵥ| and μ,

$$\frac{\partial ( 12 )}{\partial \vert 𝒬 ( v , w ) \vert} = {μ}^{2} - {( \frac{{τ}_{w} - {τ}_{v}}{\vert 𝒬 ( v , w ) \vert} )}^{2} {<}_{( a )} {μ}^{2} - {( \frac{μ ( \vert ℐ \vert - 1 )}{\vert 𝒬 ( v , w ) \vert} )}^{2} {<}_{( b )} {μ}^{2} - {( \frac{μ ( \vert ℐ \vert - 1 )}{( \vert ℐ \vert - 1 )} )}^{2} = 0 ,$$

where inequality (a) holds because of the assumption Tw−Tv>μ(|I|−1) and inequality (b) is due to |Q(v, w)|≦|I|−1. So (12) is a decreasing function of |Q(v, w)| (the length of the path).

Let η denote the length of the longest path between v and w. Given the longest path between v and w, we can construct a spreading tree P* by generating T* using the breadth-first search starting from the longest path and assigning timestamps t* as mentioned above. Then,

$$C ( v ) = C ( {𝒫}^{*} ) = {min}_{{𝒫}_{v} ∈ ℒ ( ℐ , τ )} C ( {𝒫}_{v} ) = {η ( \frac{{τ}_{w} - {τ}_{v}}{η} - μ )}^{2} . \qquad ( 13 )$$

Therefore, the algorithm that computes C(v) can be used to find the longest path between Nodes v and w. Since the longest path problem is NP-hard, the calculation of C(v) must also be NP-hard.

### Proof of Theorem 2

Note that the complexity of the modified breadth first search is O(|ε_{I}|) since each edge in the subgraph formed by the infected nodes only needs to be considered once. The complexity of EIF is analyzed next:
Step 1: The complexity of computing the paths from an infected node to all other infected nodes is O(|ε_{I}|). Given |α| infected nodes with timestamps, the computational complexity of Step 1 is O(|α∥ε_{I}|).
Step 2: The complexity of sorting a list of size |α| is O(|α|log|α|).
Steps 3 and 4: To construct the spreading tree for a given node, |α| infected nodes need to be attached in Steps 3 and 4. Each attachment requires the construction of a modified breadth-first tree, which has complexity O(|ε_{I}|). So the overall computational complexity of Steps 3 and 4 is O(|α∥ε_{I}|).
Step 5: The breadth-first search algorithm is needed to complete the spreading tree, which has complexity O(|ε_{I}|).

From the discussion above, it can be concluded that the computational complexity of constructing the spreading tree from a given node and calculating the associated cost is O(|α∥ε_{I}|). CR (or TR) repeats EIF for each infected node, with complexity O(|α∥I∥ε_{I}|), and then sort the infected nodes, with complexity O(|I|log|I|). Therefore, the overall complexity of CR (or TR) is O(|α∥I∥ε_{I}|).

### Additional Experimental Evaluation

In this section, additional experiments were conducted including the comparison to Lappas' algorithm under the IC model, the evaluation of the algorithms' scalability and the evaluation using normalized rank.

### D.1 Comparison to Lappas' Algorithm

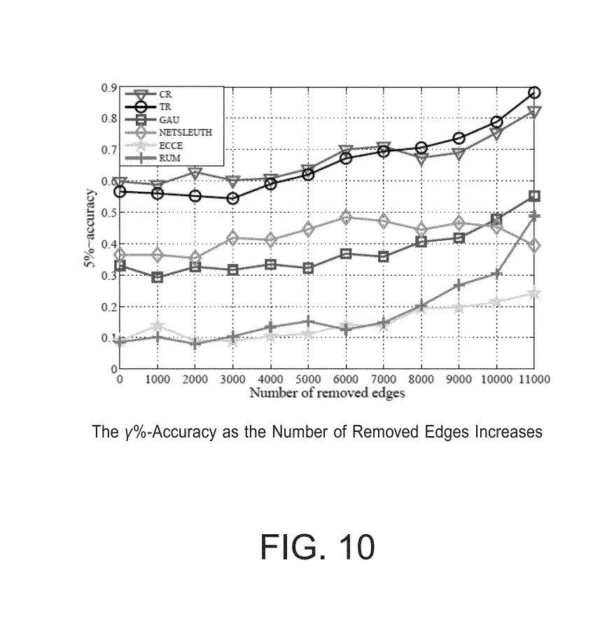

The performance of the algorithm (Lappas' algorithm) was evaluated. Lappas' algorithm was developed for the IC model and requires the infection probabilities of the IC model. Therefore, we only the algorithm on the IC model was compared and the results shown in FIG. 10. The experiments settings are the same as those in Section 5.2. It is assumed that 50% timestamps are observed for the TR, CR and GAU algorithms. As shown in FIG. 10, the γ %-accuracy of Lappas' algorithm on the IAS network is significantly smaller than the TR and CR algorithms when γ≧10. In the PG network, the TR and CR algorithms dominates Lappas' algorithm for all γ.

### D.2 Scalability

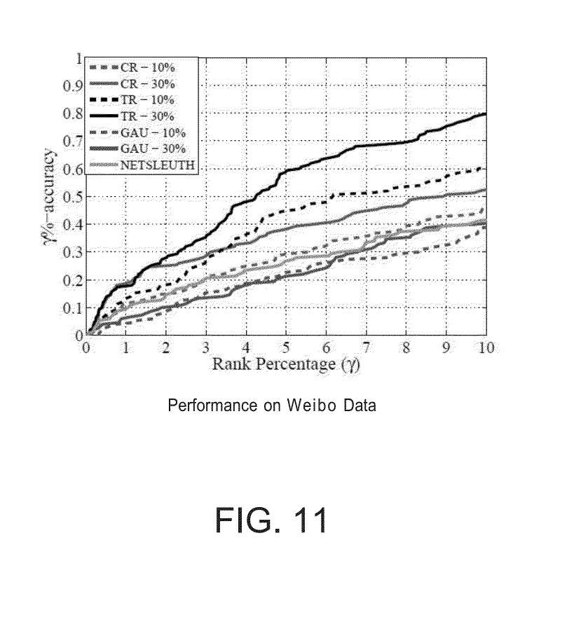

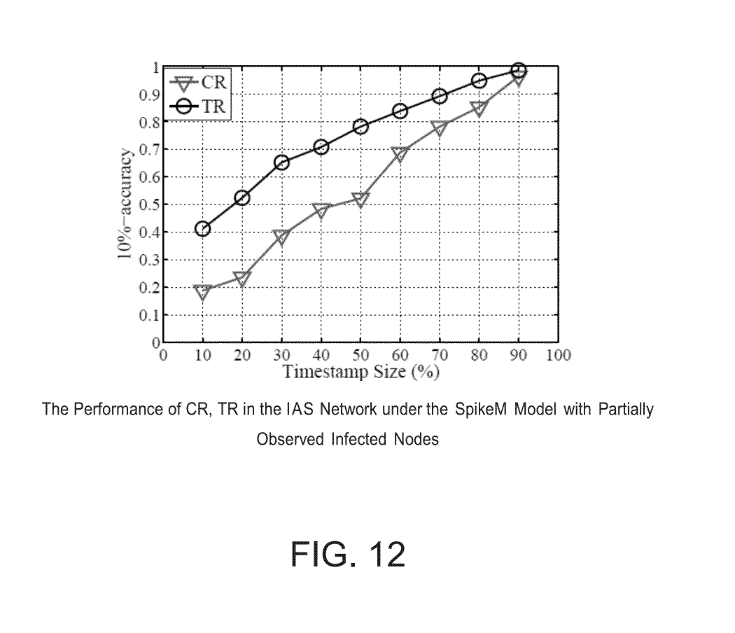

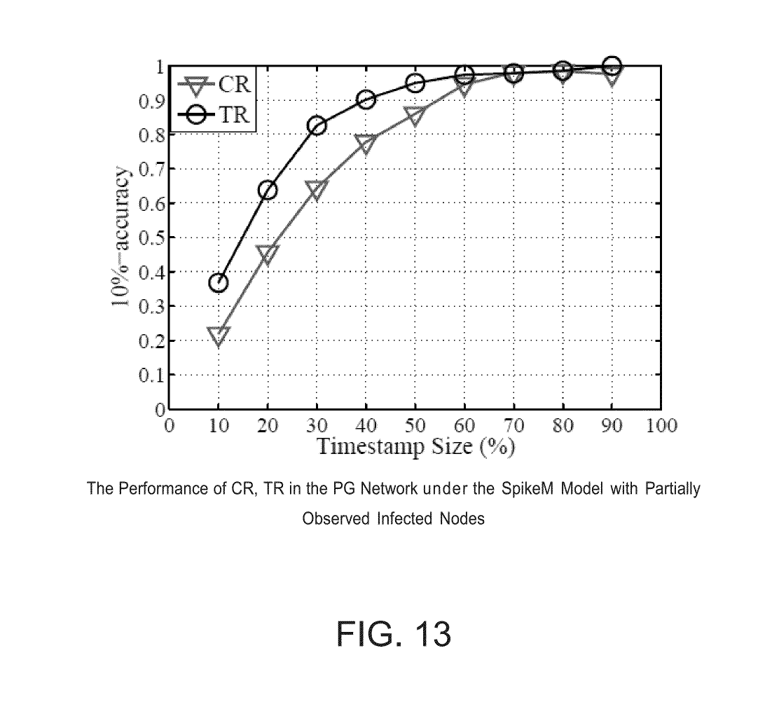

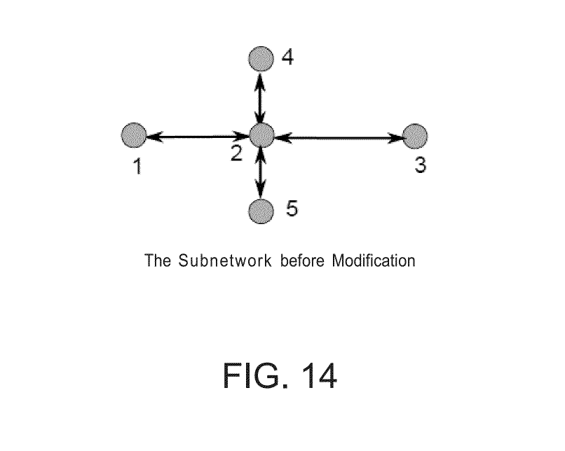

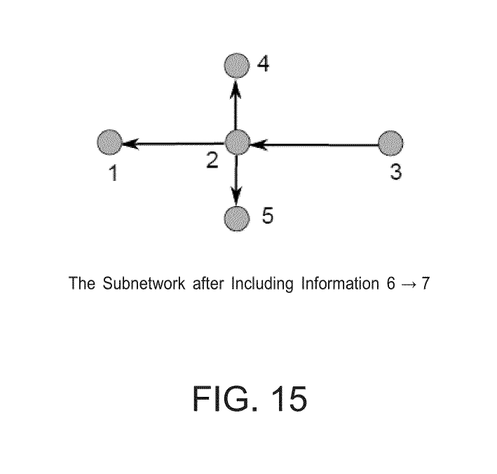

The execution time of the algorithms was measured as shown in FIG. 11. The experiments are conducted on an Intel Core i5-3210M CPU with four cores and 8G RAM with a Windows 7 Professional 64 bit system. All algorithms are implemented with python 2.7. All the other settings are the same as those in Section 5.2 with μ=100. As shown in FIG. 11, CR and TR are more than six times faster than GAU when 50% timestamps are observed. Although some other algorithms which do not use timestamps are faster, their performances are worse than TR, CR and GAU. Lappas' algorithm is significantly slower than all the algorithms since Lappas' algorithm is based on the full network while other algorithms are only based on the network with infected nodes or the neighbors of the infected nodes. In addition, as shown in FIG. 11B, the mean and the standard deviation of the running time of TR and CR are much smaller than those of GAU when the available timestamps are more than 10%. Furthermore, the running time of TR and CR remains roughly the same as the number of timestamps increases while the running time of GAU increases significantly initially and then decreases a little bit. The decrease is because when more timestamps are observed, only the infected nodes with unobserved timestamps and the node which has the earliest observed timestamps could be the source which reduces the number of candidates hence the total running time.

### D.3 Normalized Rank

In addition to the γ %-accuracy, we further evaluated the performance of the algorithms using the normalized rank, which is defined to be the ratio between the rank of the actual source and the total number of infected nodes. The observations are similar to the γ %-accuracy except that CR performs better in the IAS network than TR in most cases and TR performs better in the PG network. The difference between GAU and TR & CR are smaller. The results show TR and CR not only achieved much better “accuracy-at-the-top”, but also improved the normalized rank in most cases.

### D.3.1 The Impact of Timestamp Distribution

Tables 6, 7, 8, 9, 10 and 11 show the normalized rank for the truncated Gaussian model for the IAS network and the PG network. The settings of the experiments are same as those in Section 5.3. In the IAS network, the CR algorithm yields the smallest normalized ranks and standard deviations when there are more than 10% of timestamps are observed.

TABLE 6
Normalized Rank (Mean ± Standard Deviation) for Different Distributions and
Sizes of Timestamps on the IAS Network When μ = 1

| Timestamp | | | | | | GAU |
|---|---|---|---|---|---|---|
| Size | CR | TR | GAU | CR (Biased) | TR (Biased) | (Biased) |
| 10% | 0.29 ± 0.25 | 0.31 ± 0.29 | 0.25 ± 0.25 | 0.32 ± 0.24 | 0.36 ± 0.29 | 0.29 ± 0.25 |
| 20% | 0.18 ± 0.18 | 0.23 ± 0.25 | 0.21 ± 0.21 | 0.22 ± 0.20 | 0.27 ± 0.26 | 0.25 ± 0.22 |
| 30% | 0.14 ± 0.15 | 0.17 ± 0.20 | 0.18 ± 0.18 | 0.17 ± 0.17 | 0.21 ± 0.22 | 0.21 ± 0.19 |
| 40% | 0.11 ± 0.13 | 0.14 ± 0.17 | 0.14 ± 0.16 | 0.13 ± 0.13 | 0.17 ± 0.18 | 0.18 ± 0.16 |
| 50% | 0.07 ± 0.09 | 0.11 ± 0.14 | 0.13 ± 0.13 | 0.10 ± 0.11 | 0.13 ± 0.15 | 0.15 ± 0.14 |
| 60% | 0.06 ± 0.07 | 0.08 ± 0.10 | 0.10 ± 0.10 | 0.07 ± 0.07 | 0.10 ± 0.12 | 0.13 ± 0.11 |
| 70% | 0.04 ± 0.05 | 0.06 ± 0.08 | 0.07 ± 0.07 | 0.05 ± 0.05 | 0.07 ± 0.08 | 0.09 ± 0.08 |
| 80% | 0.03 ± 0.03 | 0.04 ± 0.05 | 0.05 ± 0.05 | 0.03 ± 0.03 | 0.04 ± 0.05 | 0.06 ± 0.05 |
| 90% | 0.02 ± 0.01 | 0.02 ± 0.02 | 0.03 ± 0.03 | 0.02 ± 0.02 | 0.03 ± 0.02 | 0.04 ± 0.03 |

TABLE 7
Normalized Rank (Mean ± Standard Deviation) for Different Distributions and
Sizes of Timestamps on the IAS Network When μ = 10

| Timestamp | | | | | | GAU |
|---|---|---|---|---|---|---|
| Size | CR | TR | GAU | CR (Biased) | TR (Biased) | (Biased) |
| 10% | 0.27 ± 0.23 | 0.30 ± 0.28 | 0.26 ± 0.24 | 0.31 ± 0.24 | 0.34 ± 0.30 | 0.30 ± 0.26 |
| 20% | 0.18 ± 0.18 | 0.23 ± 0.26 | 0.21 ± 0.22 | 0.21 ± 0.20 | 0.27 ± 0.25 | 0.26 ± 0.23 |
| 30% | 0.14 ± 0.15 | 0.17 ± 0.20 | 0.19 ± 0.19 | 0.16 ± 0.16 | 0.21 ± 0.22 | 0.23 ± 0.20 |
| 40% | 0.10 ± 0.12 | 0.13 ± 0.17 | 0.16 ± 0.16 | 0.13 ± 0.13 | 0.16 ± 0.18 | 0.19 ± 0.17 |
| 50% | 0.08 ± 0.09 | 0.10 ± 0.14 | 0.13 ± 0.13 | 0.10 ± 0.10 | 0.13 ± 0.15 | 0.16 ± 0.13 |
| 60% | 0.05 ± 0.06 | 0.07 ± 0.10 | 0.10 ± 0.10 | 0.07 ± 0.07 | 0.09 ± 0.10 | 0.13 ± 0.11 |
| 70% | 0.04 ± 0.05 | 0.06 ± 0.08 | 0.08 ± 0.08 | 0.05 ± 0.06 | 0.07 ± 0.08 | 0.10 ± 0.08 |
| 80% | 0.02 ± 0.02 | 0.04 ± 0.05 | 0.06 ± 0.05 | 0.04 ± 0.04 | 0.04 ± 0.05 | 0.07 ± 0.05 |
| 90% | 0.02 ± 0.01 | 0.02 ± 0.02 | 0.03 ± 0.03 | 0.02 ± 0.02 | 0.03 ± 0.02 | 0.04 ± 0.03 |

In the PG network, TR yields the smallest normalized ranks and standard deviations.

### D.3.2 the Impact of the Diffusion Model

Tables 12, 13, 14 and 15 show the normalized rank under the IC model and SpikeM model. The settings are the same as that in Section 5.4. GAU has better or similar performance as TR and CR when the fraction of observed timestamps is small, but yields a larger normalized rank when the number of observed timestamps increases.

### D.3.3 the Impact of Network Topology

Table 16 shows the normalized rank when the edges are removed from the IAS network. The settings are the same as that in Section 5.5 and CR dominates in this case.

### D.3.4 Weibo Data Evaluation

Table 17 shows the normalized rank for the Weibo data. The settings are the same as that in Section 5.6. The CR algorithm with 30% timestamps was observed to have the minimum normalized rank for all tweet cascades sizes.

TABLE 8
Normalized Rank (Mean ± Standard Deviation) for Different Distributions and
Sizes of Timestamps on the IAS Network When μ = 100

| Timestamp | | | | | | GAU |
|---|---|---|---|---|---|---|
| Size | CR | TR | GAU | CR (Biased) | TR (Biased) | (Biased) |
| 10% | 0.29 ± 0.23 | 0.31 ± 0.29 | 0.24 ± 0.23 | 0.32 ± 0.24 | 0.35 ± 0.29 | 0.29 ± 0.25 |
| 20% | 0.19 ± 0.18 | 0.22 ± 0.25 | 0.20 ± 0.20 | 0.22 ± 0.19 | 0.26 ± 0.25 | 0.25 ± 0.22 |
| 30% | 0.14 ± 0.16 | 0.18 ± 0.21 | 0.17 ± 0.18 | 0.18 ± 0.16 | 0.21 ± 0.22 | 0.21 ± 0.19 |
| 40% | 0.11 ± 0.11 | 0.13 ± 0.17 | 0.15 ± 0.16 | 0.13 ± 0.13 | 0.17 ± 0.18 | 0.17 ± 0.16 |
| 50% | 0.08 ± 0.09 | 0.10 ± 0.13 | 0.12 ± 0.12 | 0.10 ± 0.10 | 0.14 ± 0.15 | 0.16 ± 0.13 |
| 60% | 0.06 ± 0.07 | 0.08 ± 0.10 | 0.10 ± 0.10 | 0.07 ± 0.07 | 0.10 ± 0.11 | 0.12 ± 0.11 |
| 70% | 0.04 ± 0.04 | 0.06 ± 0.07 | 0.08 ± 0.08 | 0.05 ± 0.05 | 0.07 ± 0.08 | 0.09 ± 0.08 |
| 80% | 0.03 ± 0.03 | 0.04 ± 0.05 | 0.05 ± 0.05 | 0.04 ± 0.03 | 0.05 ± 0.05 | 0.06 ± 0.05 |
| 90% | 0.02 ± 0.01 | 0.02 ± 0.02 | 0.03 ± 0.03 | 0.02 ± 0.02 | 0.02 ± 0.02 | 0.04 ± 0.03 |

TABLE 9
Normalized Rank (Mean ± Standard Deviation) for Different Distributions and
Sizes of Timestamps on the PG Network When μ = 1

| Timestamp | | | | | | GAU |
|---|---|---|---|---|---|---|
| Size | CR | TR | GAU | CR (Biased) | TR (Biased) | (Biased) |
| 10% | 0.17 ± 0.14 | 0.10 ± 0.12 | 0.12 ± 0.12 | 0.21 ± 0.16 | 0.17 ± 0.17 | 0.19 ± 0.16 |
| 20% | 0.09 ± 0.09 | 0.06 ± 0.08 | 0.08 ± 0.10 | 0.14 ± 0.11 | 0.09 ± 0.10 | 0.14 ± 0.13 |
| 30% | 0.06 ± 0.05 | 0.04 ± 0.04 | 0.06 ± 0.07 | 0.10 ± 0.08 | 0.06 ± 0.07 | 0.11 ± 0.11 |
| 40% | 0.04 ± 0.04 | 0.03 ± 0.03 | 0.04 ± 0.04 | 0.07 ± 0.06 | 0.05 ± 0.05 | 0.08 ± 0.08 |
| 50% | 0.03 ± 0.02 | 0.02 ± 0.02 | 0.03 ± 0.04 | 0.06 ± 0.05 | 0.04 ± 0.04 | 0.06 ± 0.06 |
| 60% | 0.02 ± 0.01 | 0.02 ± 0.02 | 0.02 ± 0.02 | 0.04 ± 0.04 | 0.03 ± 0.03 | 0.05 ± 0.05 |
| 70% | 0.01 ± 0.01 | 0.01 ± 0.01 | 0.02 ± 0.02 | 0.03 ± 0.03 | 0.02 ± 0.02 | 0.04 ± 0.04 |
| 80% | 0.01 ± 0.01 | 0.01 ± 0.00 | 0.02 ± 0.01 | 0.03 ± 0.02 | 0.02 ± 0.02 | 0.03 ± 0.03 |
| 90% | 0.01 ± 0.00 | 0.01 ± 0.00 | 0.01 ± 0.01 | 0.02 ± 0.01 | 0.02 ± 0.01 | 0.02 ± 0.02 |

TABLE 10
Normalized Rank (Mean ± Standard Deviation) for Different Distributions and
Sizes of Timestamps on the PG Network When μ = 10

| Timestamp | | | | | | GAU |
|---|---|---|---|---|---|---|
| Size | CR | TR | GAU | CR (Biased) | TR (Biased) | (Biased) |
| 10% | 0.16 ± 0.14 | 0.09 ± 0.11 | 0.12 ± 0.13 | 0.22 ± 0.17 | 0.14 ± 0.14 | 0.19 ± 0.16 |
| 20% | 0.09 ± 0.09 | 0.05 ± 0.07 | 0.08 ± 0.09 | 0.14 ± 0.11 | 0.10 ± 0.11 | 0.14 ± 0.13 |
| 30% | 0.06 ± 0.05 | 0.03 ± 0.04 | 0.05 ± 0.06 | 0.10 ± 0.08 | 0.07 ± 0.07 | 0.11 ± 0.11 |
| 40% | 0.04 ± 0.03 | 0.03 ± 0.03 | 0.04 ± 0.04 | 0.08 ± 0.07 | 0.05 ± 0.05 | 0.08 ± 0.08 |
| 50% | 0.03 ± 0.02 | 0.02 ± 0.02 | 0.03 ± 0.04 | 0.05 ± 0.05 | 0.04 ± 0.04 | 0.07 ± 0.07 |
| 60% | 0.02 ± 0.01 | 0.01 ± 0.01 | 0.03 ± 0.03 | 0.05 ± 0.04 | 0.03 ± 0.03 | 0.05 ± 0.05 |
| 70% | 0.02 ± 0.01 | 0.01 ± 0.01 | 0.02 ± 0.02 | 0.04 ± 0.03 | 0.03 ± 0.02 | 0.04 ± 0.04 |
| 80% | 0.01 ± 0.01 | 0.01 ± 0.01 | 0.02 ± 0.01 | 0.03 ± 0.02 | 0.02 ± 0.02 | 0.03 ± 0.03 |
| 90% | 0.01 ± 0.00 | 0.01 ± 0.00 | 0.01 ± 0.01 | 0.02 ± 0.01 | 0.02 ± 0.01 | 0.02 ± 0.02 |

TABLE 11
Normalized Rank (Mean ± Standard Deviation) for Different Distributions and
Sizes of Timestamps on the PG Network When μ = 100

| Timestamp | | | | | | GAU |
|---|---|---|---|---|---|---|
| Size | CR | TR | GAU | CR (Biased) | TR (Biased) | (Biased) |
| 10% | 0.15 ± 0.14 | 0.09 ± 0.11 | 0.10 ± 0.10 | 0.21 ± 0.15 | 0.14 ± 0.15 | 0.17 ± 0.15 |
| 20% | 0.09 ± 0.09 | 0.05 ± 0.06 | 0.06 ± 0.07 | 0.14 ± 0.11 | 0.09 ± 0.09 | 0.12 ± 0.11 |
| 30% | 0.05 ± 0.05 | 0.03 ± 0.04 | 0.04 ± 0.05 | 0.10 ± 0.08 | 0.06 ± 0.07 | 0.08 ± 0.08 |
| 40% | 0.04 ± 0.03 | 0.03 ± 0.03 | 0.03 ± 0.03 | 0.07 ± 0.06 | 0.04 ± 0.04 | 0.07 ± 0.06 |
| 50% | 0.03 ± 0.02 | 0.02 ± 0.02 | 0.03 ± 0.03 | 0.05 ± 0.04 | 0.04 ± 0.04 | 0.05 ± 0.05 |
| 60% | 0.02 ± 0.01 | 0.01 ± 0.01 | 0.02 ± 0.02 | 0.04 ± 0.03 | 0.03 ± 0.03 | 0.04 ± 0.04 |
| 70% | 0.01 ± 0.01 | 0.01 ± 0.01 | 0.02 ± 0.01 | 0.03 ± 0.02 | 0.02 ± 0.02 | 0.03 ± 0.03 |
| 80% | 0.01 ± 0.01 | 0.01 ± 0.01 | 0.01 ± 0.01 | 0.02 ± 0.02 | 0.02 ± 0.01 | 0.03 ± 0.02 |
| 90% | 0.01 ± 0.00 | 0.01 ± 0.00 | 0.01 ± 0.01 | 0.02 ± 0.01 | 0.02 ± 0.01 | 0.02 ± 0.01 |

TABLE 12
Normalized Rank (Mean ± Standard Deviation) for Different Distributions and
Sizes of Timestamps on the IAS Network under the IC Model

| Timestamp | | | | | | GAU |
|---|---|---|---|---|---|---|
| Size | CR | TR | GAU | CR (Biased) | TR (Biased) | (Biased) |
| 10% | 0.33 ± 0.26 | 0.32 ± 0.29 | 0.18 ± 0.24 | 0.39 ± 0.27 | 0.39 ± 0.29 | 0.18 ± 0.22 |
| 20% | 0.22 ± 0.23 | 0.22 ± 0.25 | 0.16 ± 0.20 | 0.28 ± 0.24 | 0.27 ± 0.26 | 0.16 ± 0.20 |
| 30% | 0.16 ± 0.19 | 0.17 ± 0.21 | 0.16 ± 0.18 | 0.20 ± 0.20 | 0.21 ± 0.22 | 0.15 ± 0.18 |
| 40% | 0.11 ± 0.15 | 0.12 ± 0.17 | 0.16 ± 0.16 | 0.16 ± 0.18 | 0.17 ± 0.19 | 0.14 ± 0.15 |
| 50% | 0.08 ± 0.11 | 0.08 ± 0.13 | 0.13 ± 0.13 | 0.12 ± 0.14 | 0.12 ± 0.16 | 0.12 ± 0.13 |
| 60% | 0.05 ± 0.08 | 0.06 ± 0.10 | 0.11 ± 0.10 | 0.08 ± 0.10 | 0.08 ± 0.12 | 0.10 ± 0.10 |
| 70% | 0.04 ± 0.06 | 0.04 ± 0.07 | 0.08 ± 0.08 | 0.05 ± 0.07 | 0.05 ± 0.08 | 0.09 ± 0.08 |
| 80% | 0.02 ± 0.04 | 0.02 ± 0.04 | 0.06 ± 0.05 | 0.03 ± 0.04 | 0.03 ± 0.05 | 0.06 ± 0.05 |
| 90% | 0.01 ± 0.02 | 0.01 ± 0.02 | 0.03 ± 0.03 | 0.02 ± 0.02 | 0.02 ± 0.02 | 0.03 ± 0.03 |

TABLE 13
Normalized Rank (Mean ± Standard Deviation) for Different Distributions and
Sizes of Timestamps on the IAS Network under the SpikeM Model

| Timestamp | | | | | | GAU |
|---|---|---|---|---|---|---|
| Size | CR | TR | GAU | CR (Biased) | TR (Biased) | (Biased) |
| 10% | 0.35 ± 0.26 | 0.34 ± 0.29 | 0.27 ± 0.26 | 0.36 ± 0.27 | 0.36 ± 0.29 | 0.31 ± 0.26 |
| 20% | 0.24 ± 0.22 | 0.26 ± 0.26 | 0.24 ± 0.23 | 0.29 ± 0.23 | 0.31 ± 0.27 | 0.25 ± 0.22 |
| 30% | 0.20 ± 0.19 | 0.20 ± 0.23 | 0.21 ± 0.20 | 0.23 ± 0.20 | 0.24 ± 0.23 | 0.23 ± 0.20 |
| 40% | 0.15 ± 0.16 | 0.17 ± 0.20 | 0.19 ± 0.17 | 0.18 ± 0.17 | 0.19 ± 0.19 | 0.19 ± 0.16 |
| 50% | 0.13 ± 0.13 | 0.13 ± 0.16 | 0.17 ± 0.14 | 0.15 ± 0.14 | 0.15 ± 0.16 | 0.18 ± 0.14 |
| 60% | 0.09 ± 0.10 | 0.09 ± 0.12 | 0.13 ± 0.11 | 0.11 ± 0.11 | 0.11 ± 0.12 | 0.14 ± 0.11 |
| 70% | 0.07 ± 0.08 | 0.07 ± 0.09 | 0.10 ± 0.09 | 0.08 ± 0.08 | 0.08 ± 0.09 | 0.11 ± 0.09 |
| 80% | 0.05 ± 0.05 | 0.05 ± 0.06 | 0.08 ± 0.06 | 0.06 ± 0.05 | 0.05 ± 0.06 | 0.07 ± 0.06 |
| 90% | 0.03 ± 0.03 | 0.03 ± 0.03 | 0.04 ± 0.03 | 0.03 ± 0.03 | 0.03 ± 0.03 | 0.05 ± 0.03 |

TABLE 14
Normalized Rank (Mean ± Standard Deviation) for Different Distributions and
Sizes of Timestamps on the PG Network under the IC Model

| Timestamp | | | | | | GAU |
|---|---|---|---|---|---|---|
| Size | CR | TR | GAU | CR (Biased) | TR (Biased) | (Biased) |
| 10% | 0.13 ± 0.13 | 0.10 ± 0.13 | 0.13 ± 0.14 | 0.19 ± 0.15 | 0.18 ± 0.18 | 0.22 ± 0.18 |
| 20% | 0.07 ± 0.08 | 0.06 ± 0.09 | 0.09 ± 0.12 | 0.13 ± 0.11 | 0.12 ± 0.13 | 0.17 ± 0.15 |
| 30% | 0.04 ± 0.04 | 0.04 ± 0.07 | 0.07 ± 0.08 | 0.09 ± 0.08 | 0.09 ± 0.11 | 0.13 ± 0.12 |
| 40% | 0.03 ± 0.03 | 0.03 ± 0.07 | 0.05 ± 0.06 | 0.06 ± 0.05 | 0.06 ± 0.08 | 0.11 ± 0.10 |
| 50% | 0.02 ± 0.02 | 0.02 ± 0.04 | 0.04 ± 0.05 | 0.05 ± 0.04 | 0.05 ± 0.07 | 0.10 ± 0.09 |
| 60% | 0.01 ± 0.01 | 0.02 ± 0.03 | 0.04 ± 0.04 | 0.04 ± 0.03 | 0.04 ± 0.05 | 0.09 ± 0.08 |
| 70% | 0.01 ± 0.01 | 0.01 ± 0.02 | 0.03 ± 0.03 | 0.03 ± 0.02 | 0.03 ± 0.04 | 0.07 ± 0.06 |
| 80% | 0.01 ± 0.01 | 0.01 ± 0.02 | 0.02 ± 0.02 | 0.02 ± 0.02 | 0.02 ± 0.03 | 0.06 ± 0.04 |
| 90% | 0.01 ± 0.00 | 0.01 ± 0.01 | 0.02 ± 0.01 | 0.02 ± 0.01 | 0.02 ± 0.01 | 0.03 ± 0.02 |

TABLE 15
Normalized Rank (Mean ± Standard Deviation) for Different Distributions and
Sizes of Timestamps on the PG Network under the SpikeM Model

| Timestamp | | | | | | GAU |
|---|---|---|---|---|---|---|
| Size | CR | TR | GAU | CR (Biased) | TR (Biased) | (Biased) |
| 10% | 0.18 ± 0.15 | 0.10 ± 0.12 | 0.11 ± 0.11 | 0.24 ± 0.16 | 0.15 ± 0.15 | 0.17 ± 0.14 |
| 20% | 0.10 ± 0.09 | 0.06 ± 0.07 | 0.06 ± 0.07 | 0.14 ± 0.10 | 0.09 ± 0.08 | 0.11 ± 0.10 |
| 30% | 0.06 ± 0.06 | 0.03 ± 0.04 | 0.04 ± 0.04 | 0.10 ± 0.08 | 0.06 ± 0.06 | 0.07 ± 0.07 |
| 40% | 0.04 ± 0.04 | 0.03 ± 0.02 | 0.03 ± 0.03 | 0.07 ± 0.05 | 0.04 ± 0.04 | 0.05 ± 0.05 |
| 50% | 0.03 ± 0.03 | 0.02 ± 0.02 | 0.02 ± 0.02 | 0.05 ± 0.04 | 0.04 ± 0.03 | 0.04 ± 0.04 |
| 60% | 0.02 ± 0.02 | 0.02 ± 0.01 | 0.02 ± 0.02 | 0.04 ± 0.03 | 0.03 ± 0.02 | 0.03 ± 0.03 |
| 70% | 0.02 ± 0.01 | 0.02 ± 0.01 | 0.02 ± 0.01 | 0.03 ± 0.02 | 0.02 ± 0.02 | 0.03 ± 0.02 |
| 80% | 0.02 ± 0.01 | 0.01 ± 0.00 | 0.01 ± 0.01 | 0.03 ± 0.02 | 0.02 ± 0.01 | 0.02 ± 0.02 |
| 90% | 0.01 ± 0.00 | 0.01 ± 0.00 | 0.01 ± 0.01 | 0.02 ± 0.01 | 0.02 ± 0.01 | 0.02 ± 0.01 |

TABLE 16
Normalized Rank (Mean ± Standard Deviation) as the Number of Removed
Edges Increases in the IAS Network

| Edges | | | | | | |
|---|---|---|---|---|---|---|
| Removed | CR | TR | GAU | NETSLEUTH | ECCE | RUM |
| 0 | 0.08 ± 0.09 | 0.10 ± 0.13 | 0.12 ± 0.12 | 0.31 ± 0.32 | 0.42 ± 0.30 | 0.53 ± 0.32 |
| 1000 | 0.08 ± 0.10 | 0.10 ± 0.13 | 0.13 ± 0.13 | 0.29 ± 0.31 | 0.41 ± 0.30 | 0.52 ± 0.33 |
| 2000 | 0.07 ± 0.09 | 0.11 ± 0.14 | 0.13 ± 0.13 | 0.30 ± 0.31 | 0.42 ± 0.29 | 0.54 ± 0.32 |
| 3000 | 0.07 ± 0.09 | 0.11 ± 0.14 | 0.13 ± 0.13 | 0.25 ± 0.30 | 0.42 ± 0.29 | 0.52 ± 0.33 |
| 4000 | 0.07 ± 0.08 | 0.09 ± 0.13 | 0.12 ± 0.12 | 0.26 ± 0.30 | 0.42 ± 0.30 | 0.49 ± 0.34 |
| 5000 | 0.07 ± 0.08 | 0.09 ± 0.12 | 0.12 ± 0.12 | 0.25 ± 0.29 | 0.39 ± 0.29 | 0.48 ± 0.33 |
| 6000 | 0.06 ± 0.08 | 0.08 ± 0.12 | 0.11 ± 0.12 | 0.21 ± 0.26 | 0.35 ± 0.29 | 0.41 ± 0.31 |
| 7000 | 0.06 ± 0.08 | 0.08 ± 0.12 | 0.12 ± 0.12 | 0.21 ± 0.27 | 0.34 ± 0.27 | 0.39 ± 0.31 |
| 8000 | 0.06 ± 0.08 | 0.07 ± 0.12 | 0.10 ± 0.11 | 0.21 ± 0.26 | 0.33 ± 0.28 | 0.38 ± 0.32 |
| 9000 | 0.06 ± 0.08 | 0.06 ± 0.11 | 0.10 ± 0.11 | 0.19 ± 0.25 | 0.32 ± 0.30 | 0.35 ± 0.32 |
| 10000 | 0.05 ± 0.06 | 0.05 ± 0.09 | 0.08 ± 0.10 | 0.18 ± 0.23 | 0.34 ± 0.29 | 0.32 ± 0.32 |
| 11000 | 0.05 ± 0.07 | 0.03 ± 0.07 | 0.07 ± 0.10 | 0.14 ± 0.21 | 0.33 ± 0.29 | 0.29 ± 0.35 |

TABLE 17
Normalized Rank for Different Tweet Cascade Sizes (Mean ± Standard Deviation)
on the Weibo dataset.

| | Tweet cascade size | | | | |
|---|---|---|---|---|---|
| | [10, 200) | [200, 400) | [400, 600) | [600, 800) | [800, ∞) |
| | Number of samples | | | | |
| | 285 | 126 | 106 | 76 | 145 |
| CR-30% | 0.05 ± 0.05 | 0.04 ± 0.07 | 0.07 ± 0.08 | 0.10 ± 0.08 | 0.08 ± 0.08 |
| CR-10% | 0.21 ± 0.29 | 0.08 ± 0.10 | 0.12 ± 0.11 | 0.14 ± 0.12 | 0.10 ± 0.10 |
| TR-30% | 0.06 ± 0.11 | 0.08 ± 0.19 | 0.10 ± 0.19 | 0.17 ± 0.25 | 0.10 ± 0.17 |
| TR-10% | 0.23 ± 0.30 | 0.15 ± 0.24 | 0.21 ± 0.29 | 0.24 ± 0.30 | 0.23 ± 0.32 |
| GAU-30% | 0.06 ± 0.06 | 0.06 ± 0.08 | 0.11 ± 0.11 | 0.12 ± 0.10 | 0.12 ± 0.12 |
| GAU-10% | 0.06 ± 0.06 | 0.09 ± 0.11 | 0.14 ± 0.12 | 0.15 ± 0.11 | 0.14 ± 0.12 |
| NETSLEUTH | 0.36 ± 0.30 | 0.43 ± 0.35 | 0.37 ± 0.30 | 0.35 ± 0.28 | 0.36 ± 0.27 |
| ECCE | 0.06 ± 0.06 | 0.08 ± 0.10 | 0.11 ± 0.10 | 0.10 ± 0.10 | 0.11 ± 0.11 |
| RUM | 0.05 ± 0.05 | 0.09 ± 0.11 | 0.10 ± 0.11 | 0.11 ± 0.10 | 0.13 ± 0.11 |

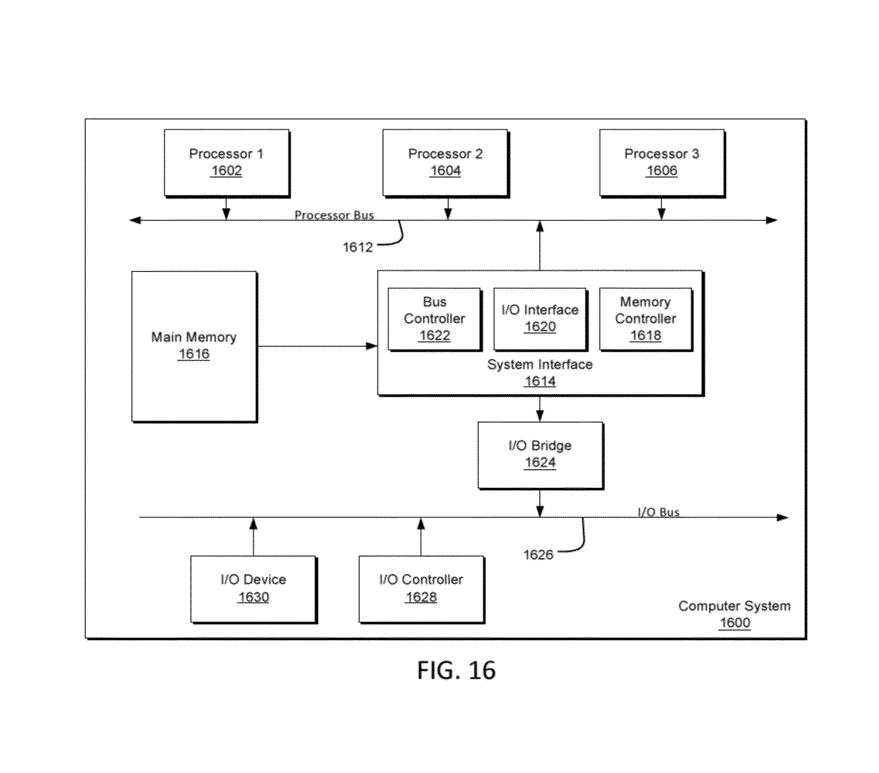

FIG. 16 is a block diagram illustrating an example of a computing device or computer system 1600 which may be used in implementing the embodiments of the present disclosure. For example, the computing system 1600 of FIG. 16 may be a computing device, such as a mobile phone, or any other portion of the network discussed above. The computer system 1600 includes one or more processors 1602-1606. Processors 1602-1606 may include one or more internal levels of cache (not shown) and a bus controller or bus interface unit to direct interaction with the processor bus 1612. Processor bus 1612, also known as the host bus or the front side bus, may be used to couple the processors 1602-1606 with the computer system interface 1614. Computer system interface 1614 may be connected to the processor bus 1612 to interface other components of the computer system 1600 with the processor bus 1612. For example, computer system interface 1614 may include a memory controller 1618 for interfacing a main memory 1616 with the processor bus 1612. The main memory 1616 typically includes one or more memory cards and a control circuit (not shown). Computer system interface 1614 may also include an input/output (I/O) interface 1620 to interface one or more I/O bridges or I/O devices with the processor bus 1612. One or more I/O controllers and/or I/O devices may be connected with the I/O bus 1626, such as I/O controller 1628 and I/O device 1630, as illustrated.

I/O device 1630 may also include an input device (not shown), such as an alphanumeric input device, including alphanumeric and other keys for communicating information and/or command selections to the processors 1602-1606. Another type of user input device includes cursor control, such as a mouse, a trackball, or cursor direction keys for communicating direction information and command selections to the processors 1602-1606 and for controlling cursor movement on the display device.

Computer system 1600 may include a dynamic storage device, referred to as main memory 1616, or a random access memory (RAM) or other computer-readable devices coupled to the processor bus 1612 for storing information and instructions to be executed by the processors 1602-1606. Main memory 1616 also may be used for storing temporary variables or other intermediate information during execution of instructions by the processors 1602-1606. System 1600 may include a read only memory (ROM) and/or other static storage device coupled to the processor bus 1612 for storing static information and instructions for the processors 1602-1606. The system set forth in FIG. 16 is but one possible example of a computer system that may employ or be configured in accordance with aspects of the present disclosure.

According to one embodiment, the above techniques may be performed by computer system 1600 in response to processor 1604 executing one or more sequences of one or more instructions contained in main memory 1616. These instructions may be read into main memory 1616 from another machine-readable medium, such as a storage device. Execution of the sequences of instructions contained in main memory 1616 may cause processors 1602-1606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 1616. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for identifying the source device of data, the method comprising:
constructing a directed graph comprising a plurality of nodes and at least one directed edge connecting each of the plurality of nodes to at least one other node of the plurality of nodes, wherein each node of the plurality of nodes represents a computing device of a network of a plurality of computing devices in communication over the network;
determining a subset of the plurality of nodes of the directed graph, the subset comprising computing devices that have received a particular dataset over the network, wherein a first portion of the subset of the plurality of nodes comprises a timestamp indicating when a particular computing device received the particular dataset;
for each particular node in the subset of the plurality of nodes:
defining a plurality of spreading tree graphs of the subset of the plurality of nodes of the directed graph, each of the plurality of spreading tree graphs comprising the first portion of the subset of the plurality of nodes and a second subset of the plurality of nodes, the second subset comprising an estimated timestamp estimating when a particular computing device represented in the second subset of the plurality of nodes received the particular dataset;
calculating a cost estimate for each of the plurality of spreading tree graphs; and
associating at least one calculated cost estimate with the particular node of the subset of the plurality of nodes of the directed graph; and
ranking the nodes of the subset of the plurality of nodes of the directed graph based on the at least one calculated cost estimate associated with each node of the subset of the plurality of nodes of the directed graph.

2. The method of claim 1 further comprising:
associating a first node of the subset of the plurality of nodes with an indicator that the computing device represented by the first node is the source of the particular dataset in the network, the first node of the subset of the plurality of nodes corresponding to the lowest cost ranked node based on the at least one calculated cost estimate associated with each node.

3. The method of claim 1 further comprising:
ranking the nodes of the subset of the plurality of nodes of the directed graph based on the timestamp or estimated timestamp for with each node of the subset of the plurality of nodes of the directed graph.

4. The method of claim 1 wherein each of the plurality of spreading tree graphs further comprise a sequence in which the first portion of the subset of the plurality of nodes and a second subset of the plurality of nodes received the particular dataset.

5. The method of claim 4 wherein each of the plurality of spreading tree graphs further comprise a time vector comprising the timestamp or estimated timestamp for with each node of the subset of the plurality of nodes of the directed graph.

6. The method of claim 1 wherein the estimated timestamp is based at least on an average of the timestamps indicating when the particular computing devices received the particular dataset.

7. The method of claim 1 wherein at least one calculated cost estimate associated with the particular node of the subset of the plurality of nodes of the directed graph is the smallest calculated cost estimate of the plurality of spreading tree graphs for that particular node.

8. The method of claim 1 further comprising:
sorting the nodes of the first portion of the subset of the plurality of nodes in ascending order based on the timestamp indicating when the particular computing device received the particular dataset.

9. The method of claim 8 further comprising:
constructing a first spreading tree graph of the plurality of spreading tree graphs starting from the highest node in the sorted order of nodes of the first portion of the subset of the plurality of nodes.

10. The method of claim 1 wherein the timestamp indicating when a particular computing device received the particular dataset comprises a date and clock time.

11. A system for managing a network, the system comprising:
at least one processing device; and
a tangible computer-readable medium with one or more executable instructions stored thereon, wherein the at least one processing device executes the one or more instructions to perform the operations of:
constructing a directed graph comprising a plurality of nodes and at least one directed edge connecting each of the plurality of nodes to at least one other node of the plurality of nodes, wherein each node of the plurality of nodes represents a computing device of a network of a plurality of computing devices in communication over the network;
determining a subset of the plurality of nodes of the directed graph, the subset comprising computing devices that have received a particular dataset over the network, wherein a first portion of the subset of the plurality of nodes comprises a timestamp indicating when a particular computing device received the particular dataset;
for each particular node in the subset of the plurality of nodes:
defining a plurality of spreading tree graphs of the subset of the plurality of nodes of the directed graph, each of the plurality of spreading tree graphs comprising the first portion of the subset of the plurality of nodes and a second subset of the plurality of nodes, the second subset comprising an estimated timestamp estimating when a particular computing device represented in the second subset of the plurality of nodes received the particular dataset;
calculating a cost estimate for each of the plurality of spreading tree graphs; and
associating at least one calculated cost estimate with the particular node of the subset of the plurality of nodes of the directed graph; and
ranking the nodes of the subset of the plurality of nodes of the directed graph based on the at least one calculated cost estimate associated with each node of the subset of the plurality of nodes of the directed graph.

12. The system of claim 11, wherein the one or more executable instructions further cause the processing device to perform the operation of:
associating a first node of the subset of the plurality of nodes with an indicator that the computing device represented by the first node is the source of the particular dataset in the network, the first node of the subset of the plurality of nodes corresponding to the lowest cost ranked node based on the at least one calculated cost estimate associated with each node.

13. The system of claim 11, wherein the one or more executable instructions further cause the processing device to perform the operation of:
ranking the nodes of the subset of the plurality of nodes of the directed graph based on the timestamp or estimated timestamp for with each node of the subset of the plurality of nodes of the directed graph.

14. The system of claim 11, wherein each of the plurality of spreading tree graphs further comprise a sequence in which the first portion of the subset of the plurality of nodes and a second subset of the plurality of nodes received the particular dataset.

15. The system of claim 14, wherein each of the plurality of spreading tree graphs further comprise a time vector comprising the timestamp or estimated timestamp for with each node of the subset of the plurality of nodes of the directed graph.

16. The system of claim 11, wherein the estimated timestamp is based at least on an average of the timestamps indicating when the particular computing devices received the particular dataset.

17. The system of claim 11, wherein at least one calculated cost estimate associated with the particular node of the subset of the plurality of nodes of the directed graph is the smallest calculated cost estimate of the plurality of spreading tree graphs for that particular node.

18. The system of claim 11, wherein the one or more executable instructions further cause the processing device to perform the operation of:
sorting the nodes of the first portion of the subset of the plurality of nodes in ascending order based on the timestamp indicating when the particular computing device received the particular dataset.

19. The system of claim 18, wherein the one or more executable instructions further cause the processing device to perform the operation of:
constructing a first spreading tree graph of the plurality of spreading tree graphs starting from the highest node in the sorted order of nodes of the first portion of the subset of the plurality of nodes.

20. The system of claim 11 wherein the timestamp indicating when a particular computing device received the particular dataset comprises a date and clock time.
